(19) United States
(12) Patent Application Publication
(10) Pub. No.: US 2020/0327491 A1
(43) Pub. Date: Oct. 15, 2020

(54) PRESENTATION APPARATUS AND PRESENTATION METHOD

(71) Applicant: Panasonic Corporation, Osaka (JP)

(72) Inventors: YURI NISHIKAWA, Kanagawa (JP); JUN OZAWA, Nara (JP)

(21) Appl. No.: 16/915,395

(22) Filed: Jun. 29, 2020

Related U.S. Application Data
(63) Continuation of application No. PCT/JP2018/046255, filed on Dec. 17, 2018.

(30) Foreign Application Priority Data
Jan. 26, 2018 (JP) 2018-011401

(51) Int. Cl. G06Q 10/08; H04W 4/029; G01C 21/34; G01C 21/26; G01S 19/01

(52) U.S. Cl. CPC G06Q 10/0833; H04W 4/029; G01S 19/01; G01C 21/265; G01C 21/3407

(57) ABSTRACT

A presentation apparatus includes a memory storing candidate information indicating delivery location candidates determined on the basis of a history of current positions of a user. If first positional information indicating a current position of a delivery vehicle is received, areas within a first distance from the delivery location candidates are compared with the current position. If areas within the first distance from one or more of the delivery location candidates include the current position, alternative information indicating that the package can be delivered to one or more alternative delivery locations, which are the one or more of the delivery location candidates, is transmitted to a second terminal. If delivery location information indicating one of the one or more alternative delivery locations is received from the second terminal, presentation information indicating that the package is to be delivered to the alternative delivery location is transmitted to a first terminal.

### BACKGROUND

### 1. Technical Field

The present disclosure relates to a technique for presenting delivery locations of packages for users to a delivery vehicle.

### 2. Description of the Related Art

With the spread of online shopping, more and more packages now need to be delivered by delivery vehicles. A particular problem is the increase in deliver costs for redelivery due to absence of users who are supposed to receive the packages. Japanese Unexamined Patent Application Publication No. 2004-338888 discloses a method to search for stores where a package can be delivered based on user's destination information and a delivery time.

### SUMMARY

The technique disclosed in Japanese Unexamined Patent Application Publication No. 2004-338888, however, needs to be further improved.

One non-limiting and exemplary embodiment provides a technique for delivering a package to a location convenient to a user and reduce the amount of packages that have to be redelivered without increasing travel distance of a delivery vehicle.

In one general aspect, the techniques disclosed here feature a presentation apparatus that presents, to a delivery vehicle, information indicating a delivery location of a package to be delivered by the delivery vehicle to each of one or more users, the presentation apparatus including a memory storing, for each of the one or more users, candidate information indicating one or more delivery location candidates, which are candidates for the delivery location, determined on a basis of movement history information indicating a history of current positions of the user, a communicator that communicates information with a first terminal, which is an information terminal provided for the delivery vehicle, and one or more second terminals, which are information terminals used by the one or more users, and a processor that performs a process using information received by the communicator and information stored in the memory. The memory stores in advance, in order of delivery for the one or more users, package information in which user identifiers for identifying the one or more users, package identifiers for identifying the packages for the one or more users, delivery location information indicating delivery locations specified by the one or more users, third or fourth information, and preferred delivery time information indicating times preferred by the one or more users at which the packages are to be delivered associated with one another. The third information indicates that the delivery location indicated by the delivery location information is a location specified by each of the one or more users and the fourth information indicates that the delivery location indicated by the delivery location information is a location determined on a basis of the candidate information regarding each of the one or more users. The processor obtains a user identifier, delivery location information, and preferred delivery time information associated in the package information with a package identifier of a package to be delivered, obtains second positional information indicating a current position of a change target user identified by the obtained user ID from movement history information regarding the change target user, estimates, on a basis of the obtained second positional information, target delivery location information, which is the obtained delivery location information, and the obtained preferred delivery time information, whether the change target user will be absent from a delivery location indicated by the target delivery location information at the time indicated by the obtained preferred delivery time information, obtains, if estimating that the change target user will be absent, next delivery location information, which is delivery location information associated in the package information with a package ID of a package to be delivered next, calculates a driving route of the delivery vehicle from the delivery location indicated by the target delivery location information to a delivery location indicated by the next delivery location information, compares areas within a first distance from positions of one or more target candidates, which are one or more delivery location candidates indicated by the candidate information regarding the change target user, with positions on the driving route, causes, if areas within the first distance from the positions of one or more of the one or more target candidates include a position on the driving route, the communicator to transmit alternative information for determining one or more close delivery locations, which are the one or more of the one or more target candidates, as the one or more alternative delivery locations, and causes, if the communicator receives delivery location information indicating one of the one or more alternative delivery locations from the second terminal used by the change target user, the communicator to transmit, to the first terminal, presentation information indicating that the package for the change target user is to be delivered to the alternative delivery location indicated by the delivery location information.

According to the present disclosure, a package can be delivered to a location convenient for the user without increasing the distance traveled by the delivery vehicle, thus preventing redelivery. As a result, it is possible to reduce the costs of fuel for delivery vehicles and the labor cost of drivers for redelivery of packages.

It should be noted that general or specific aspects may be implemented as a method, a system, an integrated circuit, a computer program, a computer-readable storage medium, which may be a nonvolatile storage medium such as a compact disc read-only memory (CD-ROM), or any selective combination thereof.

Additional benefits and advantages of the disclosed embodiments will be apparent from the specification and drawings. The benefits and/or advantages may be individually provided by some embodiments and features described in the specification and drawings, which need not all be provided in order to obtain one or more of such benefits and/or advantages.

### BRIEF DESCRIPTION OF THE DRAWINGS

FIG. 1 is a diagram illustrating an example of the network configuration of a presentation system according to an embodiment of the present disclosure;

FIG. 2 is a block diagram illustrating an example of a detailed configuration of the presentation system illustrated in FIG. 1;

FIG. 3 is a diagram illustrating an outline of a process performed by the presentation system illustrated in FIG. 2;

FIG. 4 is a diagram illustrating an outline of a comparison process;

FIG. 5 is a diagram illustrating a selection screen indicating alternative information displayed on a user terminal;

FIG. 6 is a diagram illustrating an example of a display screen indicating presentation information displayed on a delivery terminal;

FIG. 7 is a diagram illustrating an outline of a method for setting user area information;

FIG. 8 is a flowchart illustrating an example of a process for setting user area information;

FIG. 9 is a diagram illustrating an example of a movement history table;

FIG. 10 is a diagram illustrating an example of an area table;

FIG. 11 is a diagram illustrating an example of a customer table;

FIG. 12 is a diagram illustrating an example of a notification screen indicating setting completion information displayed on the user terminal;

FIG. 13 is a diagram illustrating an example of a package table;

FIG. 14 is a flowchart illustrating a first example of a process performed by a server when a user is absent;

FIG. 15 is a diagram illustrating another example of the package table;

FIG. 16 is a flowchart illustrating a first example of a process performed by the server before a delivery vehicle starts;

FIG. 17 is a diagram illustrating another example of the package table;

FIG. 18 is a flowchart illustrating a second example of the process performed by the server before the delivery vehicle starts;

FIG. 19 is a diagram illustrating an example of a package table after the process illustrated in FIG. 18 is performed;

FIG. 20 is a diagram illustrating an example of an attribute-dependent delivery table;

FIG. 21 is a diagram illustrating another example of the area table;

FIG. 22 is a diagram illustrating a second example of the process performed by the server when the user is absent;

FIG. 23 is a diagram illustrating another example of the package table;

FIG. 24 is a diagram illustrating another example of the attribute-dependent delivery table;

FIG. 25 is a flowchart illustrating a third example of the process performed by the server when the user is absent;

FIG. 26 is a diagram illustrating another example of the customer table; and

FIG. 27 is a diagram illustrating an example of operation screens used by the user to set user area information.

### DETAILED DESCRIPTION

### Underlying Knowledge Forming Basis of Present Disclosure

The present inventors have found that the conventional method causes the problem described below. An example of the related art discloses a method to search for stores where products can be delivered based on a destination of a user and a delivery time. This method has been devised in order to deliver a product at an exact time desired by a user on the move in a ready-to-eat food delivery service such as sushi and pizza.

The purpose of this method is to search for stores where products can be prepared for food delivery. When this method is applied to a general-purpose logistics system, the distance traveled by a delivery vehicle will increase because a package needs to be delivered to a user's transit location even if it is far from a current position of the package.

This method is impractical because it requires more delivery vehicles and drivers. Furthermore, general packages is different from prepared meals, and users do not necessarily want to receive the packages at exact time they want it. It is often sufficient to be able to accept the packages at a location and time that is easy for the user to receive it.

The present disclosure has been conceived in view of the above problem and aims to provide a technique for delivering a package to a location convenient to a user and reduce redelivery without increasing a travel distance of a delivery vehicle.

A presentation apparatus according to a first aspect of the present disclosure is a presentation apparatus that presents, to a delivery vehicle, information indicating a delivery location of a package to be delivered by the delivery vehicle to each of one or more users. The presentation apparatus includes a memory storing, for each of the one or more users, candidate information indicating one or more delivery location candidates, which are candidates for the delivery location, determined on a basis of movement history information indicating a history of current positions of the user, a communicator that communicates information with a first terminal, which is an information terminal provided for the delivery vehicle, and one or more second terminals, which are information terminals used by the one or more users, and a processor that performs a process using information received by the communicator and information stored in the memory. If the communicator receives, from the first terminal, first positional information indicating a current position of the delivery vehicle, the processor performs, for each of the one or more users, a process for comparing areas within a first distance from positions of one or more delivery location candidates indicated by the candidate information regarding a target user with the current position of the delivery vehicle indicated by the received first positional information, causes, if areas within the first distance from the positions of one or more of the one or more delivery location candidates include the current position of the delivery vehicle, the communicator to transmit, to the second terminal used by the target user, alternative information indicating that the package for the target user is deliverable to one or more alternative delivery locations, which are the one or more of the one or more delivery location candidates, and causes, if the communicator receives delivery location information indicating one of the one or more alternative delivery locations from the second terminal used by the target user, the communicator to transmit, to the first terminal, presentation information indicating that the package for the target user is to be delivered to the alternative delivery location indicated by the delivery location information.

According to this aspect, if a current position of a delivery vehicle is within the first distance from positions of one or more alternative delivery locations among one or more delivery location candidates associated with a history of current positions of a user, alternative information indicating that a package can be delivered to the one or more alternative delivery locations is transmitted to a second terminal used by the user. As a result, the user is notified that the package can be delivered to the one or more alternative delivery locations associated with positions estimated to have been visited by the user.

It is assumed that, in response to the notification, the presentation apparatus receives delivery location information indicating one of the one or more alternative delivery locations from the second terminal used by the user. In this case, presentation information indicating that the package for the user is to be delivered to the alternative delivery location indicated by the delivery location information is transmitted to a first terminal provided for the delivery vehicle. As a result, a driver of the delivery vehicle is notified that the package for the user is to be delivered to an alternative delivery location that is estimated to have been visited by the user and that is located within the first distance from the current position of the delivery vehicle. Consequently, the driver of the delivery vehicle can deliver the package to the alternative delivery location that is familiar and convenient to the user only by moving the delivery vehicle the first distance at most.

According to this aspect, therefore, a package can be delivered to a location convenient to the user and it will reduce the amount of packages that have to be redelivered. As a result, it is possible to reduce the costs such as fuel for the delivery vehicle and labor cost of the driver for redelivery

In addition, in the above aspect, the memory may store in advance, for each of the one or more users, package information in which a package identifier for identifying the package for the user, delivery location information indicating delivery locations specified by the users, and attribute information indicating an attribute of the package for the user are associated with one another and attribute-dependent information in which the attribute information and first information indicating that a package having an attribute indicated by the attribute information is to be delivered to the delivery location indicated by the delivery location information or second information indicating that the package having the attribute indicated by the attribute information is to be delivered to one of the delivery location candidates included in the candidate information are associated with each other. The processor may obtain, if the communicator receives a package identifier from the first terminal, attribute information associated in the package information with the received package identifier, cause, if the first information is associated in the attribute-dependent information with the obtained attribute information, the communicator not to transmit the alternative information, and cause, if the second information is associated, the communicator to transmit the alternative information.

According to this aspect, if a package identifier is received from the first terminal, attribute information associated in the package information with the received package identifier is obtained. If the first information is associated in the attribute-dependent information with the obtained attribute information, alternative information is not transmitted. If a package identified by a package identifier and received from the first terminal has an attribute associated with the first information, therefore, delivery of the package to one of delivery location candidates included in candidate information can be appropriately avoided as indicated by the first information.

If the second information is associated in the attribute-dependent information with the obtained attribute information, on the other hand, alternative information is transmitted. When a package identified by a package identifier received from the first terminal has an attribute associated with the second information, therefore, the package can be delivered to one of delivery location candidates included in candidate information as indicated by the second information. Therefore, it will reduce the amount of packages that have to be redelivered.

In addition, in the above aspect, the attribute information may indicate a type of package. The memory may store in advance area information in which one or more area identifiers for identifying one or more storage locations capable of storing packages and type information indicating one or more types of package storable in each of the one or more storage locations are associated with each other. Each of the one or more delivery location candidates indicated by the candidate information may be determined as one of the one or more storage locations. The processor may obtain, if the second information is associated in the attribute-dependent information with target attribute information, which is the obtained attribute information, one or more area identifiers associated in the area information with type information indicating that packages of a type indicated by the target attribute information is storable and compare, in the comparison process, areas within the first distance from positions of, among the one or more delivery location candidates indicated by the candidate information regarding the target user, one or more delivery location candidates identified by the obtained one or more area identifiers with the current position of the delivery vehicle indicated by the received first positional information.

It is assumed that attribute information associated in the package information with a package identifier received from the first terminal is obtained and the second information is associated in the attribute-dependent information with target attribute information, which is the obtained attribute information. In this case, according to this aspect, in the comparison process, areas within the first distance from positions of, among one or more delivery location candidates indicated by candidate information regarding a target user, one or more delivery location candidates that have been obtained using area information and that are capable of storing packages having an attribute indicated by the target attribute information are compared with a current position of a delivery vehicle indicated by first positional information received from the first terminal. Alternative information transmitted to the second terminal as a result of the comparison process, therefore, does not include one or more alternative delivery locations incapable of storing packages having the attribute indicated by the target attribute information.

Alternatively, in the above aspect, the attribute information associated in the attribute-dependent information with the second information may be further associated with upper limit values of distance the packages can be transported. The processor may obtain, if the second information is associated in the attribute-dependent information with target attribute information, which is the obtained attribute information, delivery location information associated in the package information with the received package identifier and compare, in the comparison process, areas within the first distance from positions of, among the one or more delivery location candidates indicated by the candidate information regarding the target user, one or more delivery location candidates whose distances from one or more alternative delivery locations indicated by the obtained delivery location information are equal to or smaller than the upper limit value associated in the attribute-dependent information with the target attribute information with the current position of the delivery vehicle indicated by the received first positional information.

It is assumed that attribute information associated in the package information with a package identifier received from the first terminal is obtained and the second information is associated in the attribute-dependent information with target attribute information, which is the obtained attribute information. In this case, according to this aspect, in the comparison process, areas within the first distance from positions of, among one or more delivery location candidates indicated by candidate information regarding a target user, one or more delivery location candidates whose distances from a delivery location specified by the target user are equal to or smaller than an upper limit value of distance over which packages having an attribute indicated by the target attribute information are carriable are compared with a current position of a delivery vehicle indicated by first positional information received from the first terminal.

Alternative information transmitted to the second terminal as a result of the comparison process, therefore, does not include one or more alternative delivery locations whose distances from the delivery location specified by the target user are larger than the upper limit value of distance over which packages having the attribute indicated by the target attribute information are carriable. As a result, after receiving the package at one of the alternative delivery locations, the target user can carry the package to the specified delivery location.

In addition, in the above aspect, the attribute information may indicate weights of the packages. The first information may be associated in the attribute-dependent information with attribute information indicating that the weight of a package is equal to or larger than a certain value, and the second information may be associated with attribute information indicating that the weight of a package is smaller than the certain value.

According to this aspect, packages that have weights equal to or larger than the certain value are not delivered to alternative delivery locations. In contrast, packages having weights smaller than the certain value can be delivered to alternative delivery locations. Therefore, the amount of packages that have to be redelivered can be reduced.

Alternatively, in the above aspect, the attribute information may indicate dimensions of the packages. The first information may be associated in the attribute-dependent information with attribute information indicating that the dimension of a package is equal to or larger than a certain value, and the second information may be associated with attribute information indicating that the dimension of a package is smaller than the certain value.

According to this aspect, packages that have dimensions equal to or larger than the certain value are not delivered to alternative delivery locations. In contrast, packages having dimensions smaller than the certain value can be delivered to alternative delivery locations. Therefore, the amount of packages that have to be redelivered can be reduced.

In addition, in the first aspect, the candidate information may include one or more user area identifiers for identifying the one or more delivery location candidates. The memory may store in advance area information indicating one or more storage locations capable of storing packages. The communicator may periodically receive, from each of the one or more second terminals, a user identifier for identifying a user of the second terminal and second positional information indicating a current position of the user of the second terminal. Each time the communicator receives a user identifier and second positional information, the processor may store, in the memory as the movement history information regarding a user identified by the received user identifier, information in which the received user identifier, the received second positional information, and area identifiers for identifying storage locations that are included in the area information and that are within a second distance from a position indicated by the second positional information are associated with one another and also store one or more area identifiers, the number of which is larger than a first certain value, included in the movement history information regarding the user in the memory as one or more user area identifiers included in candidate information regarding the user.

According to this aspect, one or more area identifiers, the number of which is larger than the first certain value, included in movement history information regarding a user are stored in the memory as one or more user area identifiers for identifying one or more delivery location candidates indicated by the user. As a result, one or more storage locations estimated to have been visited by the user a number of times larger than the first certain value are determined as candidate information regarding the user. When alternative information is transmitted to a second terminal used by the user, therefore, the user is notified that a package can be delivered to one or more alternative delivery locations frequently visited by the user.

Alternatively, in the first aspect, the memory may store different pieces of the candidate information in different time periods. A piece of the candidate information corresponding to a time period may include one or more user area identifiers for identifying one or more delivery location candidates in the time period. The memory may store in advance area information indicating one or more storage locations capable of storing packages. The communicator may periodically receive, from each of the one or more second terminals, a user identifier for identifying a user of the second terminal and second positional information indicating a current position of the user of the second terminal. Each time the communicator receives a user identifier and second positional information, the processor may store, in the memory as movement history information regarding a user identified by the received user identifier, information in which a time at which the communicator received the second positional information, the received user identifier, the received second positional information, and area identifiers for identifying storage locations that are included in the area information and that are within a second distance from a position indicated by the second positional information are associated with one another, also store, among one or more area identifiers associated in the movement history information regarding the user with the time in the time period, one or more area identifiers, the number of which is larger than a second certain value, in the memory as one or more user area identifiers included in the pieces of the candidate information regarding the user corresponding to the time period, and, if a time at which the communicator received the first positional information is within the time period, compare, in the comparison process, areas within the first distance from positions of one or more delivery location candidates indicated by the piece of the candidate information regarding the user corresponding to the time period with the current position of the delivery vehicle indicated by the received first positional information.

According to this aspect, one or more area identifiers, the number of which is larger than the second certain value, associated in movement history information regarding a user with a time within a time period are stored in the memory as one or more user area identifiers for identifying one or more delivery location candidates indicated by a piece of candidate information corresponding to the time period. As a result, one or more storage locations estimated to have been visited by the user a number of times larger than the second certain value are determined as the piece of candidate information regarding the user corresponding to the time period.

If a time at which first positional information was received is within the time period, areas within the first distance from positions of one or more delivery location candidates indicated by the piece of candidate information regarding the user corresponding to the time period are compared with a current position of a delivery vehicle indicated by the received first positional information. As a result, alternative information indicating that a package can be delivered to one or more alternative delivery locations included in the one or more delivery location candidates indicated by the piece of candidate information regarding the user corresponding to the time period is transmitted to a second terminal used by the user. The user is thus notified at an appropriate timing that the package can be delivered to the one or more alternative delivery locations frequently visited by the user in the time period.

In addition, in the first aspect, the memory may store in advance package information, which is information regarding packages for the one or more users. If the communicator receives the first positional information and a package identifier for identifying a package for one of the one or more users from the first terminal, the processor may refer to candidate information regarding the user to whom the package that is included in the package information and that is identified by the received package identifier is to be delivered and compare, in the comparison process, areas within the first distance from positions of one or more delivery location candidates indicated by the candidate information regarding the user with the current position of the delivery vehicle indicated by the first positional information.

According to this aspect, if a package identifier is received when a user is absent, for example, candidate information regarding the user to whom a package identified by the received package identifier is to be delivered is referred to. If a current position of a delivery vehicle is within the first distance from positions of one or more alternative delivery locations among one or more delivery location candidates indicated by the candidate information regarding the user, alternative information indicating that the package can be delivered to the one or more alternative delivery locations is transmitted to a second terminal used by the user. As a result, the user is notified that the package can be delivered to the one or more alternative delivery locations associated with positions estimated to have been visited by the user.

If the presentation apparatus receives delivery location information indicating one of the one or more alternative delivery locations from the second terminal used by the user, therefore, presentation information indicating that the package for the user is to be delivered to the alternative delivery location indicated by the delivery location information is transmitted to the first terminal provided for the delivery vehicle. As a result, a driver of the delivery vehicle is notified that the package for the user is to be delivered to the alternative delivery location that is within the first distance from the current position of the delivery vehicle and that is estimated to have been visited by the user. Consequently, the driver of the delivery vehicle can deliver the package to the alternative delivery location that is familiar and convenient for the user to receive the package only by moving the delivery vehicle the first distance at most, thereby reducing the amount of packages that have to be redelivered.

In addition, in the first aspect, the memory may store in advance, for each of the one or more users, package information in which a user identifier for identifying the user, a package identifier for identifying the package for the user, start location information indicating a start location of the delivery vehicle at a time when the delivery vehicle delivers the package to the user, and destination information indicating a destination of the delivery vehicle at a time when the delivery vehicle delivers the package to the user are associated with one another. The processor may calculate, on the basis of one or more pieces of the start location information and the destination information included in the package information, a driving route used by the delivery vehicle until the delivery vehicle finishes delivering a final package after starting delivering a first package, compare, if the candidate information regarding the one or more users includes one or more common candidates, which are one or more delivery location candidates included in different pieces of the candidate information in common and the number of which is equal to or larger than a certain value, areas within the first distance from positions of the one or more common candidates with positions on the driving route, and causes, if areas within the first distance from positions of one or more of the one or more common candidates include a position on the driving route, the communicator to transmit, to a second terminal used by each of one or more notification target users corresponding to one or more pieces of the candidate information including any of one or more common delivery locations, which are the one or more of the one or more common candidates, alternative information for determining the one or more common delivery locations included in the candidate information regarding the notification target user as one or more alternative delivery locations.

According to this aspect, if candidate information regarding one or more users includes one or more common candidates, which are included in different pieces of the candidate information in common and the number of which is equal to or larger than the certain value, areas within the first distance from positions of the one or more common candidates are compared with positions on a driving route used by a delivery vehicle until the delivery vehicle finishes delivering a final package after starting delivering a first package. It is assumed that, as a result of the comparison, areas within the first distance from positions of one or more of the one or more common candidates (common delivery locations) include a position on the driving route. In this case, alternative information for determining the one or more of the one or more common delivery locations included in the candidate information regarding notification target users as one or more alternative delivery locations is transmitted to second terminals used by the notification target users.

As a result, if there are one or more common delivery locations within the first distance from the driving route, one or more notification target users are notified that packages can be delivered to the one or more common delivery locations. Consequently, if delivery location information is received from second terminals used by the one or more notification target users, presentation information is transmitted to the first terminal. The delivery vehicle can therefore deliver the packages for the one or more notification target users to any of the one or more common delivery locations indicated by the delivery location information. In this case, the delivery vehicle need not individually deliver the packages for the notification target users to their respective specified delivery locations and efficiently deliver the packages.

In addition, in the first aspect, the memory may store in advance, in order of delivery for the one or more users, package information in which user identifiers for identifying the one or more users, package identifiers for identifying packages for the one or more users, delivery location information indicating delivery locations specified by the one or more users, third or fourth information, and preferred delivery time information indicating times desired by the one or more users at which the packages are to be delivered associated with one another. The third information may indicate that the delivery location indicated by the delivery location information is a location specified by each of the one or more users, and the fourth information may indicate that the delivery location indicated by the delivery location information is a location determined on a basis of the candidate information regarding each of the one or more users. The processor may obtain a user identifier, delivery location information, and preferred delivery time information associated in the package information with a package identifier of a package to be delivered, obtain second positional information indicating a current position of a change target user identified by the obtained user ID from movement history information regarding the change target user, estimate, on a basis of the obtained second positional information, target delivery location information, which is the obtained delivery location information, and the obtained preferred delivery time information, whether the change target user will be absent from a delivery location indicated by the target delivery location information at the time indicated by the obtained preferred delivery time information, obtain, if estimating that the change target user will be absent, next delivery location information, which is the delivery location information associated in the package information with the package ID of a next-next package to be delivered, calculate a driving route of the delivery vehicle from the delivery location indicated by the target delivery location information to a delivery location indicated by the next delivery location information, compare areas within a first distance from positions of one or more target candidates, which are one or more delivery location candidates indicated by the candidate information regarding the change target user, with positions on the driving route, and cause, if areas within the first distance from the positions of one or more of the one or more target candidates include a position on the driving route, the communicator to transmit alternative information for determining one or more close delivery locations, which are the one or more of the one or more target candidates, as the one or more alternative delivery locations.

According to this aspect, if it is estimated that a change target user, who is a user to whom a package is to be delivered next, will be absent from a specified delivery location at a time of delivery desired by the change target user, a driving route from the delivery location to a delivery location of a next-next package is calculated. Areas within the first distance from positions of one or more target candidates indicated by candidate information regarding the change target user are then compared with positions on the driving route. It is assumed that, as a result of the comparison, areas within the first distance from positions of one or more of the one or more target candidates (close delivery locations) include a position on the driving route. In this case, alternative information for determining the one or more close delivery locations as one or more alternative delivery locations is transmitted to a second terminal used by the change target user.

As a result, if it is estimated that a change target user will be absent from a specified delivery location at a time of delivery desired by the change target user, the change target user is notified that a package can be delivered to one or more close delivery locations. The change target user therefore understands that he/she can receive the package at one of the one or more close delivery locations at a convenient time without hurrying to the specified delivery location.

### Embodiment

### Network Configuration

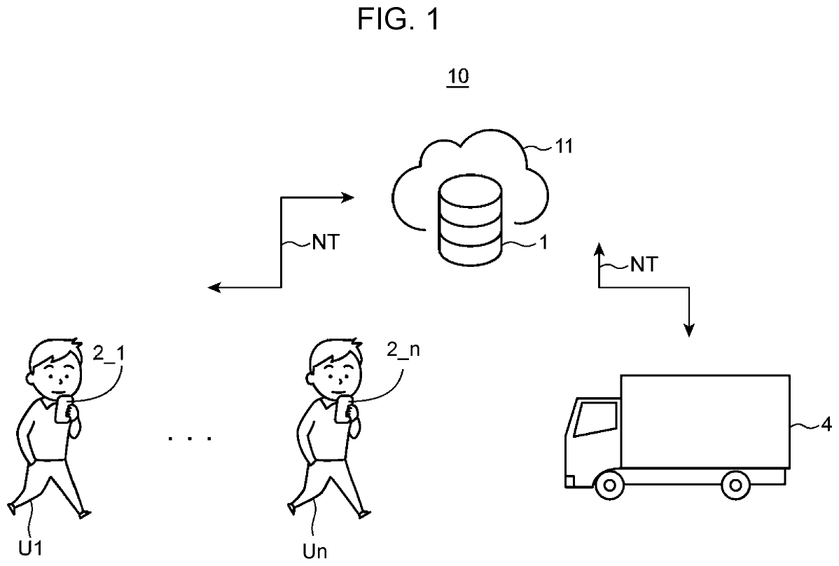

FIG. 1 is a diagram illustrating an example of a network configuration of a presentation system 10 according to an embodiment of the present disclosure. The presentation system 10 presents, to a driver of a delivery vehicle 4, information indicating delivery locations of packages for one or more users to be delivered by the delivery vehicle 4. The driver of the delivery vehicle 4 delivers the packages for the one or more users to the presented delivery locations.

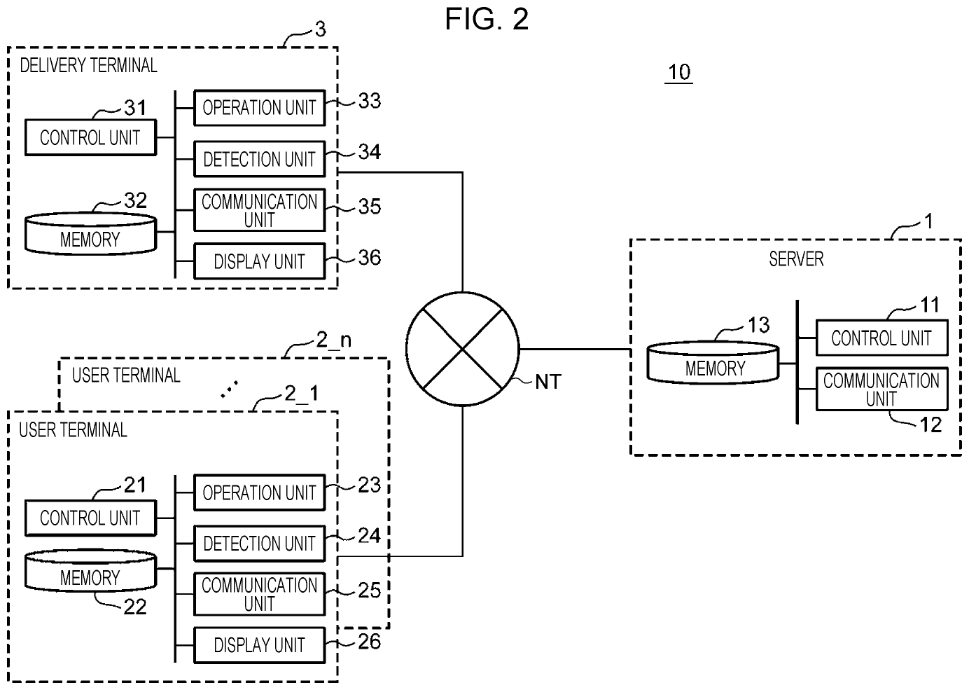

The presentation system 10 includes a server 1 (an example of a presentation apparatus), one or more user terminals 2_1 to 2_n (an example of one or more second terminals), and a delivery terminal 3 (an example of a first terminal; refer to FIG. 2). The server 1, the user terminals 2, and the delivery terminal 3 are communicably connected to one another over a network NT. The server 1 may be managed by an online shopping company that manages a shopping site or a shipping agent that delivers products purchased on shopping sites to users. The network NT is achieved, for example, by the Internet, a mobile phone network, or public telephone lines.

The server 1 is achieved, for example, by a cloud server including one or more computers. The could server that achieves the server 1 includes a processor such as a central processing unit (CPU) or a field-programmable gate array (FPGA), a memory, and a communication network that performs communication over the network NT.

The user terminals 2 are achieved, for example, mobile information terminals such as smartphones, feature phones, or tablet terminals. This, however, is just an example, and the user terminals 2 may be achieved by stationary information terminals, instead.

In the example illustrated in FIG. 1, there are n user terminals 2 (n is a natural number), namely the user terminal 2_1 of a user U1 to the user terminal 2_n of a user Un.

The delivery terminal 3 may be achieved, for example, by a computer mounted on the delivery vehicle 4 or a mobile information terminal carried by the driver of the delivery vehicle 4. The computer mounted on the delivery vehicle 4 may be, for example, an automotive navigation system or a computer equipped by the delivery vehicle 4 other than the automotive navigation system. The mobile information terminal carried by the driver may be a smartphone, a feature phone, or a tablet terminal.

FIG. 2 is a block diagram illustrating an example of a detailed configuration of the presentation system 10 illustrated in FIG. 1. The server 1 includes a control unit 11, a communication unit 12 (an example of a communicator), and a memory 13. The control unit 11 is achieved by a processor such as a CPU and executes a program for causing a computer to function as the presentation apparatus in the present disclosure. This program may be downloaded over a network or stored in a non-transitory computer-readable recording medium and provided.

The communication unit 12 is achieved, for example, by a communication circuit that connects the server 1 to the network NT and communicates information with the user terminals 2 and the delivery terminal 3 over the network NT.

The memory 13 is achieved by a nonvolatile storage device and stores the program for causing a computer to function as the presentation apparatus, tables storing information necessary for processes performed by the control unit 11, and various types of information generated as a result of the processes performed by the control unit 11.

The user terminals 2 each include a control unit 21, a memory 22, an operation unit 23, a detection unit 24, a communication unit 25, and a display unit 26. FIG. 2 illustrates the n user terminals 2_1 to 2_n corresponding to the n (n is a natural number) users, respectively. The user U1 owns the user terminal 2_1, and the user Un owns the user terminal 2_n.

The control unit 21 is achieved by a processor such as a CPU and controls the entirety of the user terminal 2. The memory 22 is achieved, for example, by a nonvolatile storage device. The memory 22 stores an application program for presenting information regarding a package to a user. The memory 22 stores a user identifier (ID) for identifying the user.

The operation unit 23 is achieved by an input device such as a touch panel or a keyboard and a mouse and receives operations performed by the user.

The detection unit 24 periodically (e.g., at intervals of 5 minutes) receives signals transmitted from global positioning system (GPS) satellites and calculates a current position of the user terminal 2 on the basis of the received signals. A current position of the user terminal 2_1 may be used as a current position of the user U1, and a current position of the user terminal 2_n may be used as a current position of the user Un.

The communication unit 25 is achieved, for example, by a communication circuit that connects the user terminal 2 to the network NT. In particular, in the present disclosure, the communication unit 25 transmits, to the server 1, positional information indicating the current position of the user terminal 2 periodically calculated by the detection unit 24 and the user ID stored in the memory 22 and receives, from the server 1, information indicating that setting of user area information, which will be described later, has been completed.

The display unit 26 is achieved, for example, by a display such as a liquid crystal display or an organic electroluminescent (EL) display and displays information regarding a package to the user.

The delivery terminal 3 includes a control unit 31, a memory 32, an operation unit 33, a detection unit 34, a communication unit 35, and a display unit 36. The control unit 31 is achieved, for example, by a processor such as a CPU and controls the entirety of the delivery terminal 3. The memory 32 is achieved by a nonvolatile storage device. The memory 32 stores an application program for presenting delivery locations of packages to the driver. The memory 32 also stores a vehicle ID for identifying the delivery vehicle 4. The operation unit 33 is achieved by an input device such as a touch panel or a keyboard and receives operations performed by the driver.

The detection unit 34 periodically (e.g., at intervals of 5 minutes) receives signals transmitted from GPS satellites and calculates a current position of the delivery terminal 3 on the basis of the received signals. The current position of the delivery terminal 3 may be used as a current position of the delivery vehicle 4.

The communication unit 35 is achieved, for example, by a communication circuit that connects the delivery terminal 3 to the network NT. In particular, in the present disclosure, the communication unit 35 transmits, to the server 1, positional information indicating the current position of the delivery terminal 3 periodically calculated by the detection unit 34, the vehicle ID stored in the memory 32 and package IDs for identifying packages that have not been delivered due to absence of users. The communication unit 35 also receives, from the server 1, information indicating delivery locations of packages for the users.

The display unit 36 is achieved by a display such as a liquid crystal display or an organic EL display. The display unit 36 displays an image indicating a delivery location of a package for a user and presents the delivery location to the driver. When the delivery terminal 3 is achieved by an automotive navigation system, the display unit 36 is achieved by a display of the automotive navigation system.

### Sequence

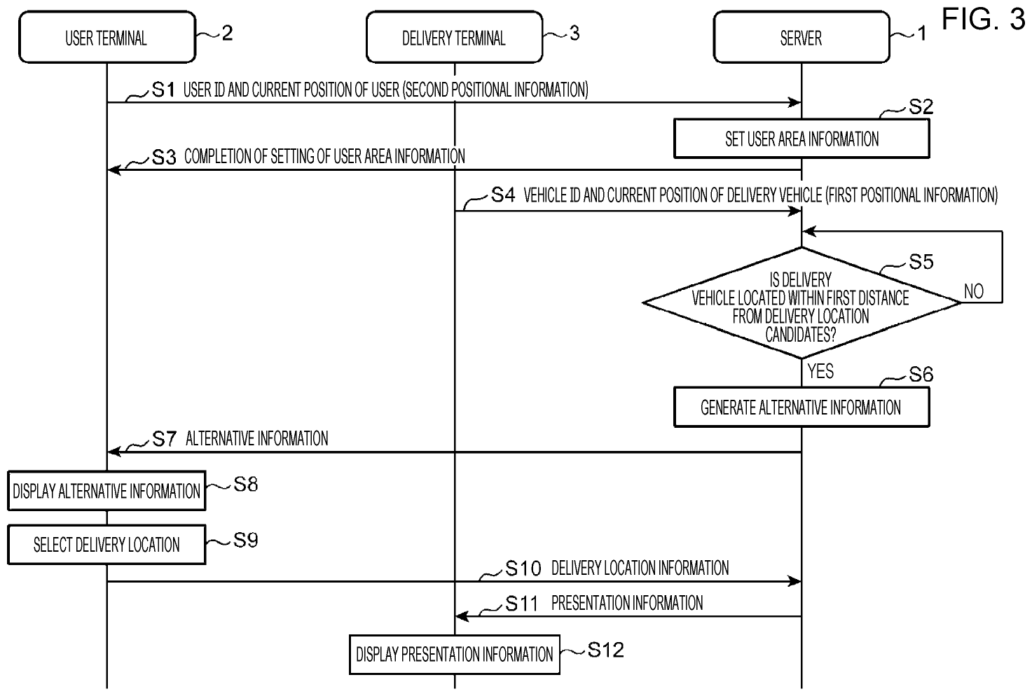

FIG. 3 is a diagram illustrating an outline of a process performed by the presentation system 10 illustrated in FIG. 2. FIG. 3 illustrates an outline of a process performed when a mode is employed in which the delivery terminal 3 displays information indicating a delivery location of a package for each user while the delivery vehicle 4 is running. This, however, is just an example. As described later, a sequence illustrated in FIG. 3 may be applied even when a mode is employed in which the delivery terminal 3 displays information indicating a delivery location of a package for each user when the user is absent or before the delivery vehicle 4 starts.

The sequence illustrated in FIG. 3 is roughly divided into two phases. In a first phase, user area information (an example of candidate information) indicating one or more delivery location candidates, which are candidates for a delivery location of a package for each of the one or more users, is set on the basis of movement history information indicating a history of current positions of the user. The first phase is represented by steps S1 to S3.

In a second phase, one or more alternative delivery locations, which are alternatives to a delivery location of the package specified by each of the one or more users, are determined on the basis of the user area information regarding the user set in the first phase, the current position of the delivery vehicle 4, and the like and presented to the driver of the delivery vehicle 4. The second phase is represented by steps S4 to S11. The second phase is performed, for example, each time the delivery terminal 3 transmits positional information indicating the current position thereof.

A case where one delivery vehicle 4 delivers packages for one or more users will be described as an example with reference to FIG. 3. The server 1 also applies the sequence illustrated in FIG. 3 to packages for one or more users delivered by another delivery vehicle 4 managed thereby to determine information indicating delivery locations of the packages and present the information to a driver of the other delivery vehicle 4.

First, the control unit 21 of each of the user terminals 2 used by the one or more users causes the communication unit 25 to transmit positional information indicating a current position of the user terminal 2 periodically calculated by the detection unit 24 to the server 1 as information (hereinafter referred to as “second positional information”) indicating a current position of the user of the user terminal 2 along with a user ID stored in the memory 22 (step S1).

Each time the communication unit 12 of the server 1 receives a user ID and second positional information from a user terminal 2, the control unit 11 sets user area information (an example of candidate information) regarding a user (hereinafter referred to as a “target user”) identified by the received user ID (step S2).

The user area information regarding the target user is information indicating one or more delivery location candidates. Each of the one or more delivery location candidates is a candidate for a delivery location of a package for the target user. As described later, the user area information regarding the target user is set on the basis of movement history information indicating a history of current positions of the target user. More specifically, among storage locations capable of storing packages, such as delivery lockers provided at supermarkets, stations, and the like, convenience stores, and post offices, ones frequently visited by the target user are determined as the delivery location candidates. Details of a method for setting user area information regarding a target user will be described later.

The control unit 11 performs step S2 each time the communication unit 12 receives a user ID and positional information regarding a user terminal 2 used by one of the one or more users. The control unit 11 thus sets user area information regarding the one or more users.

Each time the setting of user area information regarding a target user is completed, the control unit 11 causes the communication unit 12 to transmit, to the user terminal 2 used by the target user, information indicating that the setting of the user area information regarding the target user has been completed (step S3).

The first phase thus ends, and the second phase starts. The second phase starts when, for example, a target delivery vehicle 4 leaves a delivery center.

In the second phase, first, the control unit 31 of the delivery terminal 3 causes the communication unit 35 to transmit positional information regarding the delivery terminal 3 periodically calculated by the detection unit 34 to the server 1 as information (hereinafter referred to as “first positional information”) indicating a current position of the delivery vehicle 4 along with a vehicle ID stored in the memory 32 (step S4).

Each time the communication unit 12 of the server 1 receives a vehicle ID and first positional information, the control unit 11 performs a certain comparison process using the information received by the communication unit 12 and the information stored in the memory 13 (step S5).

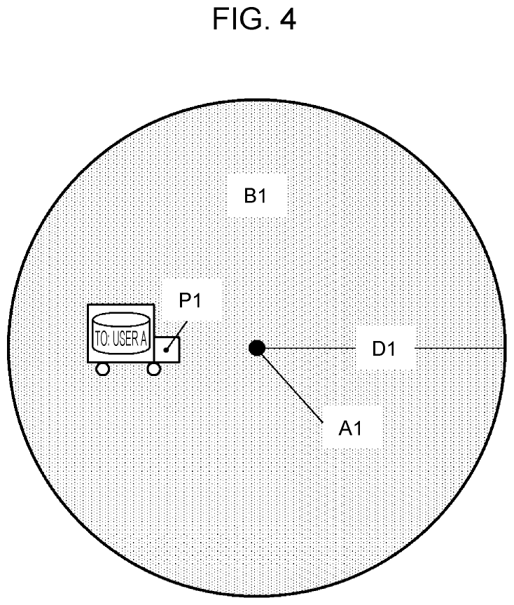

More specifically, the control unit 11 performs the comparison process in step S5 for each of the one or more users corresponding to the one or more packages to be delivered by the delivery vehicle 4. FIG. 4 is a diagram illustrating an outline of the comparison process. FIG. 4 illustrates an example in which the control unit 11 compares an area B1 within a first distance D1 from a position of a delivery location candidate A1 indicated by user area information regarding a target user with a current position P1 of the delivery vehicle 4 indicated by received first positional information. The first distance D1 is set, for example, at an upper limit value (e.g., 1 km) of distance expected to be covered by the delivery vehicle 4 to arrive at a delivery location of a next package.

The area B1 is defined by a circle whose center is the position of the delivery location candidate A1 and whose radius is D1. That is, the area B1 has an area of π×(D1)². When user area information regarding a target user indicates delivery location candidate, each of areas and a current position P1 of the delivery vehicle 4 indicated by received first positional information are compared with each other in the comparison process in step S5. The delivery location candidates and the areas are in one-to-one correspondence.

If, as a result of the comparison process, any of one or more areas that are in one-to-one correspondence with one or more delivery location candidates indicated by the user area information regarding the target user includes the current position P1 of the delivery vehicle 4 (YES in S5), the control unit 11 performs step S6. Each of the one or more areas is an area within the first distance D1 from a corresponding delivery location candidate. The one or more areas that are in one-to-one correspondence with the one or more delivery location candidates indicated by the user area information regarding the target area may be referred to as “first one or more areas”, and one or more of the one or more first areas including the current position P1 of the delivery vehicle 4 may be referred to as “second one or more areas”. In the example illustrated in FIG. 4, the current position P1 of the delivery vehicle 4 is located within the area B1 within the first distance from the position of the delivery location candidate A1. The control unit 11, therefore, determines in the comparison process in step S5 that the area B1 within the first distance D1 from the position of the delivery location candidate A1 includes the current position P1 of the delivery vehicle 4.

In step S6, the control unit 11 generates alternative information indicating that the package for the target user can be delivered to one or more alternative delivery locations, which are one or more delivery location candidates that are in one-to-one correspondence with the second one or more areas (step S6). The one or more delivery location candidates corresponding to the second one or more areas and the one or more alternative delivery locations are in one-to-one correspondence. More specifically, in step S6, the control unit 11 generates, as alternative information, information including a package ID for identifying the package for the target user, one or more user area IDs for identifying the one or more alternative delivery locations, and names of the one or more alternative delivery locations. The control unit 11 obtains these pieces of information to be included in the alternative information from the memory 13. The one or more alternative delivery locations and the one or more user area IDs are in one-to-one correspondence, and the one or more alternative delivery locations and the names of the one or more alternative delivery locations are in one-to-one correspondence.

The control unit 11 then causes the communication unit 12 to transmit the alternative information generated in step S6 to the user terminal 2 used by the target user (step S7). As a result, the target user is notified that the package can be delivered to the one or more alternative delivery locations associated with the storage locations frequently visited by the target user.

It is assumed, on the other hand, that, as a result of the comparison process performed in step S5, none of the areas within the first distance D1 from the positions of all the delivery location candidates indicated by the user area information regarding the target user includes the current position P1 of the delivery vehicle 4 (NO in step S5). It is assumed that the delivery vehicle 4 is located at a position more than the first distance D1 away from any of the positions of the delivery location candidates indicated by the user area information regarding the target user. In this case, the control unit 11 performs, without performing step S6, the comparison process in step S5 while determining another user as a target user.

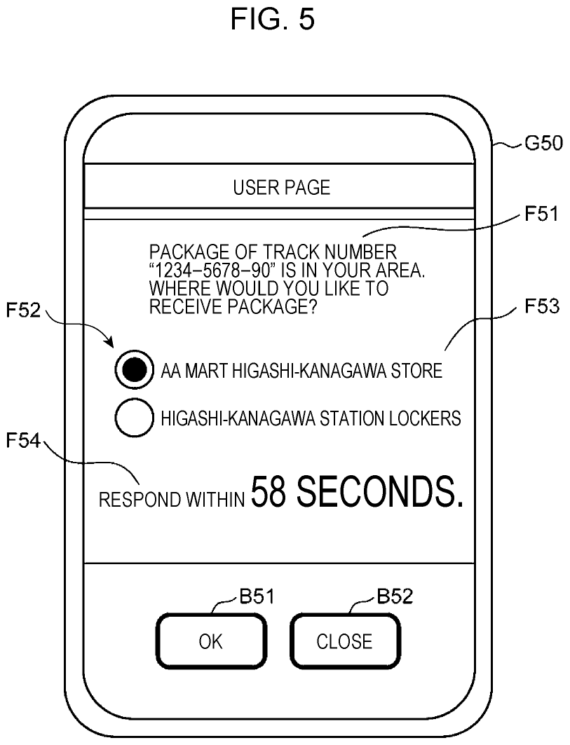

After step S7, the control unit 21 of the user terminal 2 used by the target user displays the alternative information received by the communication unit 25 on the display unit 26 (step S8). FIG. 5 is a diagram illustrating an example of a selection screen G50 indicating the alternative information displayed on the user terminal 2. More specifically, in step S8, the control unit 21 displays, on the display unit 26, the selection screen G50 indicating the alternative information received by the communication unit 25, for example, as illustrated in FIG. 5.

The selection screen G50 includes display fields F51, F53, and F54, option buttons F52, and buttons B51 and B52. The control unit 21 displays, in the display field F51, a package ID (e.g., “1234-5678-90”) for identifying a package of a target user included in the alternative information. The control unit 21 displays, in the display field F53, names (e.g., “AA Mart Higashi-Kanagawa Store” and “Higashi-Kanagawa Station Locker”) of one or more alternative delivery locations included in the alternative information. In this example, the alternative information includes two names of alternative delivery locations.

The control unit 21 displays, in the display field F54, time (e.g., 58 seconds) until the selection screen G50 is closed. More specifically, when displaying the selection screen G50, the control unit 21 displays a certain time limit (e.g., 1 minute) in the display field F54, and then decreases the time displayed in the display field F54 by a certain unit time (e.g., 1 second) each time the certain unit time elapses. When the certain time limit is reached, the control unit 21 closes the selection screen G50.

The option buttons F52 are screen parts for enabling the target user to select one of the one or more alternative delivery locations indicated by the names displayed in the display field F53 as a delivery location of the package for the target user. FIG. 5 illustrates an example in which the alternative delivery location whose name is “AA Mart Higashi-Kanagawa Store” is selected as the delivery location of the package for the target user. The button B51 is used to notify the server 1 of an alternative delivery location selected using the option buttons F52 as the delivery location of the package for the target user. The button B52 is a button for closing the selection screen G50.

It is assumed that the button B51 is pressed with any of the one or more alternative delivery locations selected by the target user using the option buttons F52 as the delivery location of the package for the target user (step S9). In this case, the control unit 21 causes the communication unit 25 to transmit delivery location information indicating the selected alternative delivery location to the server 1 (step S10).

The delivery location information includes a user area ID for identifying the selected alternative delivery location and the user ID for identifying the target user. The user area ID for identifying the selected alternative delivery location is obtained from the alternative information received by the communication unit 25. If the target user operates the operation unit 23 to press the button B52, the control unit 21 closes the selection screen G50. In this case, delivery location information is not transmitted to the server 1.

It is assumed, on the other hand, that, after the communication unit 12 of the server 1 transmits the alternative information to the user terminal 2 used by the target user, the communication unit 12 receives the delivery location information transmitted from the user terminal 2 used by the target user. In this case, the control unit 11 causes the communication unit 12 to transmit, to the delivery terminal 3, presentation information indicating that the package for the target user is to be delivered to the location indicated by the delivery location information (step S11).

The presentation information includes the package ID for identifying the package for the target user, the name of the delivery location of the package for the target user, and information indicating a position of the delivery location. The delivery location of the package for the target user is the location indicated by the delivery location information received by the communication unit 12. That is, the delivery location of the package for the target user is the alternative delivery location selected by the target user from the one or more alternative delivery locations indicated by the user area information regarding the target user. The control unit 11 obtains these pieces of information to be included in the presentation information from the memory 13.

It is assumed that the communication unit 12 has not received delivery location information from the user terminal 2 used by the target user when the certain time limit is reached after the communication unit 12 transmitted the alternative information to the user terminal 2 used by the target user in step S7. In this case, the control unit 11 does not perform step S11.

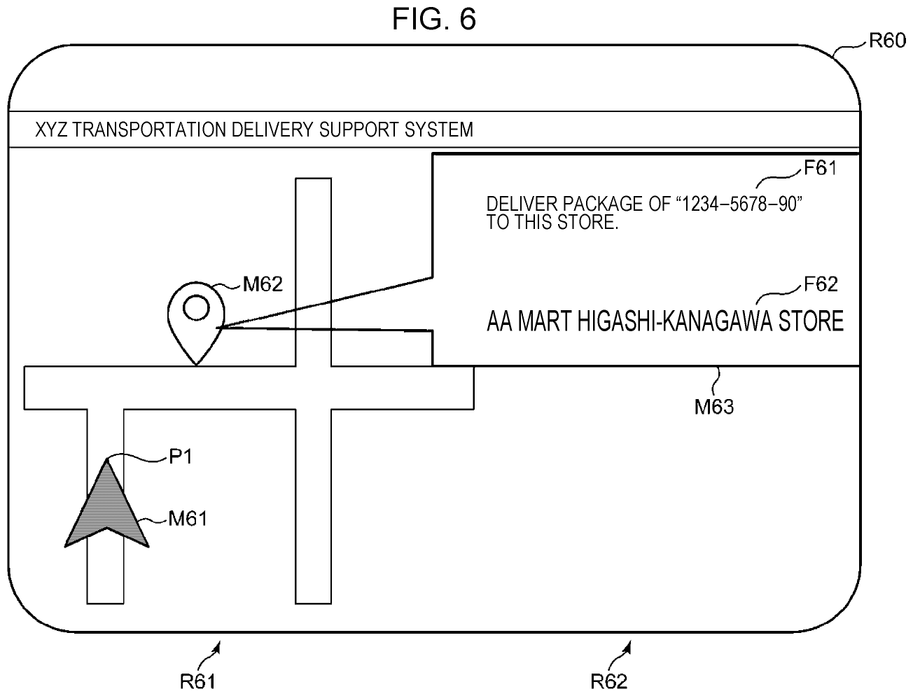

After step S11, the delivery terminal 3 displays, on the display unit 36, the presentation information received by the communication unit 35 (step S12). FIG. 6 is a diagram illustrating an example of a display screen G60 indicating the presentation information displayed on the delivery terminal 3. More specifically, in step S12, the control unit 31 displays the display screen G60 indicating the presentation information received by the communication unit 35 on the display unit 36, for example, as illustrated in FIG. 6.

The display screen G60 includes a map area R61 and a message area R62. The control unit 31 displays, in the map area R61, a map image of a certain range including the position P1 of the delivery vehicle 4. The control unit 31 obtains positional information indicating a position of the delivery location of the package for the target user included in the presentation information and displays a mark M62 indicating the delivery location at a position on the map image corresponding to the position indicated by the obtained positional information. The control unit 31 also displays a mark M61 indicating the delivery vehicle 4 at a position on the map image corresponding to the current position of the delivery vehicle 4 detected by the detection unit 34. Image data regarding the map image may be stored in the memory 32 of the delivery terminal 3 or may be included in presentation information transmitted from the server 1 in step S11.

The control unit 31 displays, in the message area R62, a balloon area M63 while associating the balloon area M63 with the mark M62 indicating the delivery location of the package for the target user displayed in the map area R61. The balloon area M63 includes display fields F61 and F62. The control unit 31 displays, in the display field F61, the package ID (e.g., “1234-5678-90”) for identifying the package for the target user included in the presentation information. The control unit 31 displays, in the display field F62, the name (e.g., “AA Mart Higashi-Kanagawa Store”) of the delivery location of the package for the target user included in the presentation information.

As a result, the driver of the delivery vehicle 4 is notified that the package for the target user is to be delivered to the alternative delivery location that is within the first distance D1 from the current position of the delivery vehicle 4 and that has been visited by the target user. The driver of the delivery vehicle 4, therefore, can deliver the package to the alternative delivery location, which has been visited by the target user and is convenient for the target user to receive the package, by moving the delivery vehicle 4 over a distance equal to or smaller than the first distance D1.

According to this mode, therefore, a package can be delivered to a location convenient for the user and the amount of packages to be redelivered can be reduced without increasing travel distance of the delivery vehicle 4. As a result, it is possible to reduce costs such as fuel for the delivery vehicle 4 and labor cost of the driver for redelivery of packages.

### Method for Setting User Area Information

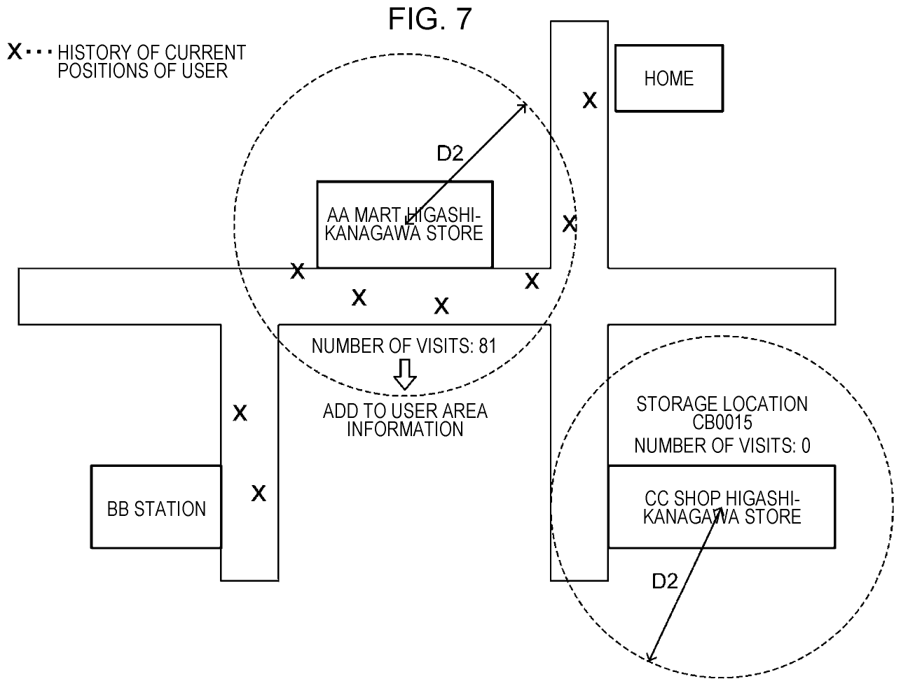

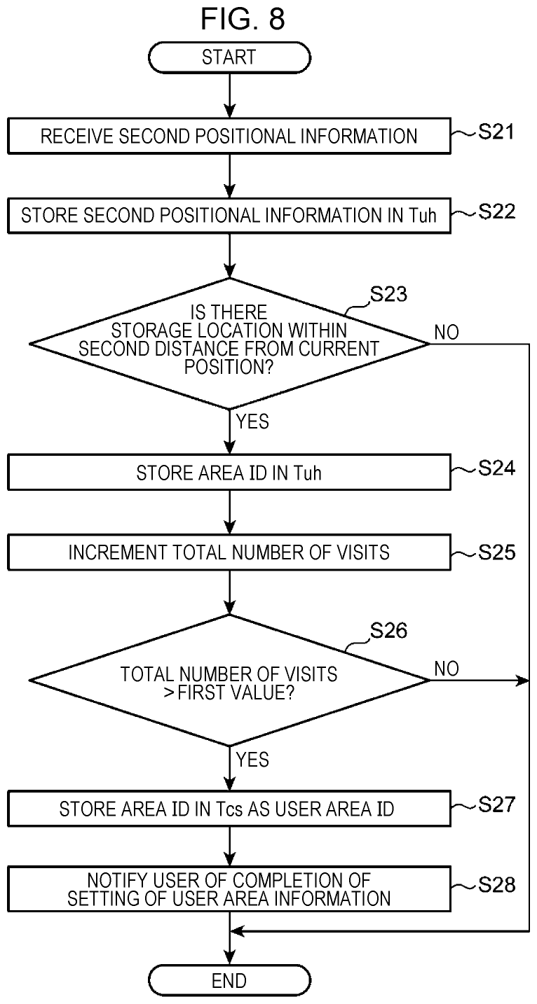

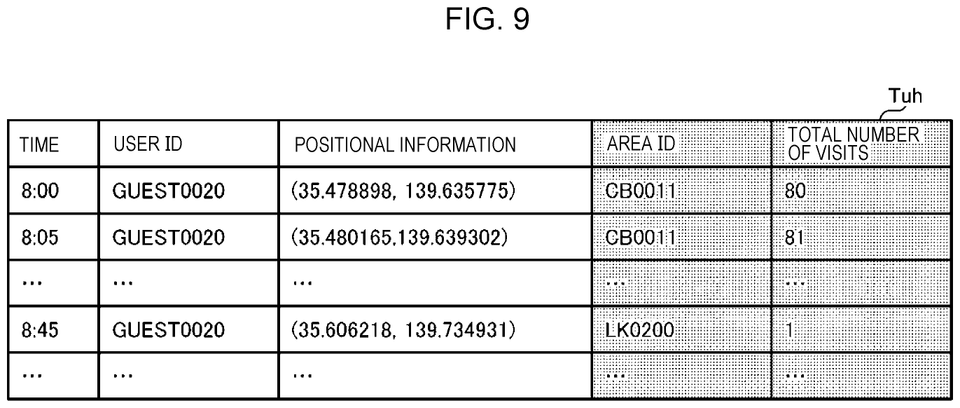

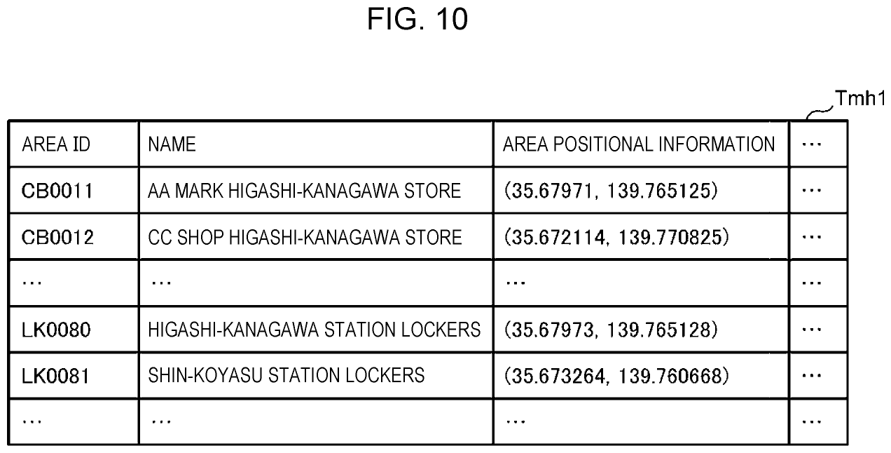

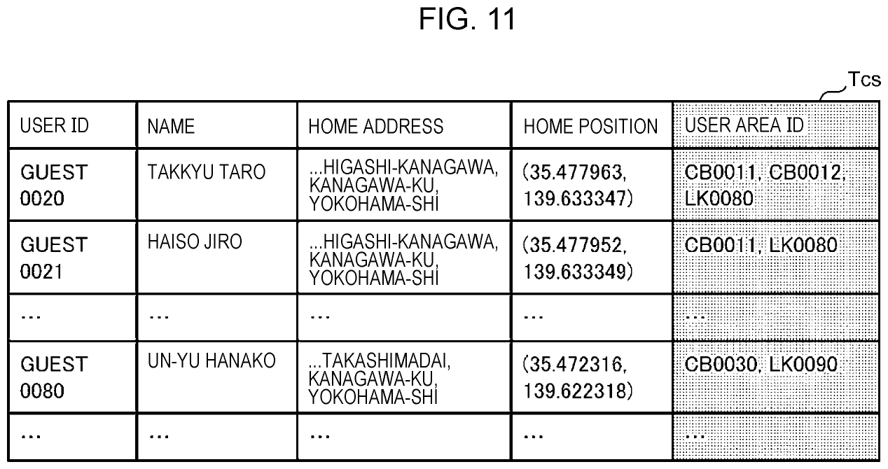

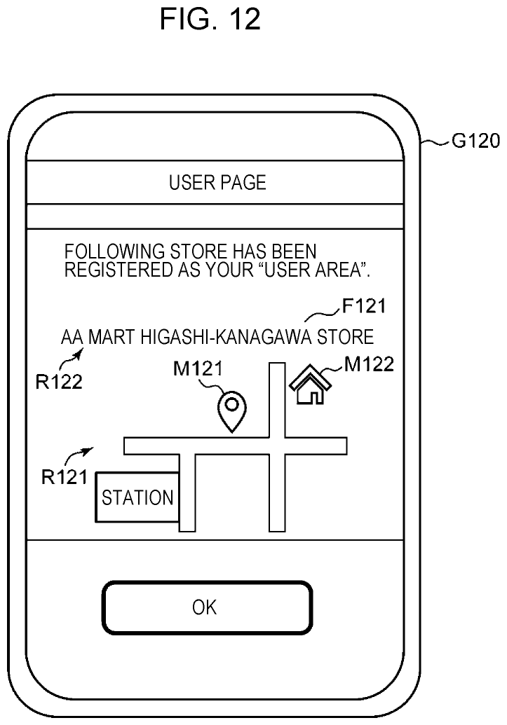

Next, the method for setting user area information regarding one or more users in steps S1 to S3 (refer to FIG. 3) will be described in detail with reference to FIGS. 7 to 12. FIG. 7 is a diagram illustrating an outline of the method for setting user area information. FIG. 8 is a flowchart illustrating an example of a process for setting user area information. FIG. 9 is a diagram illustrating an example of a movement history table Tuh. FIG. 10 is a diagram illustrating an example of an area table Tmh1. FIG. 11 is a diagram illustrating an example of a customer table Tcs. FIG. 12 is a diagram illustrating an example of a notification screen G120 indicating setting completion information displayed on the user terminal 2.

First, the outline of the method for setting user area information will be described. FIG. 7 illustrates a map image of an area round a user's home in the presentation system 10. A convenience store “AA Mart Higashi-Kanagawa Store”, a station “BB station”, and a supermarket “CC Shop Higashi-Kanagawa Store” are indicated on the map image as storage locations capable of storing packages delivered by the delivery vehicle 4. A history of current positions of the user are indicated by X's.

In the example illustrated in FIG. 7, X's concentrate in a circular area that is indicated by a broken line and that is within a second distance D2 from a position of the convenience store “AA Mart Higashi-Kanagawa Store”. A circular area that is indicated by a broken line and that is within the second distance D2 from a position of the supermarket “CC shop Higashi-Kanagawa Store”, on the other hand, does not include X's. It is therefore estimated that the user has frequently visited the convenience store “AA Mart Higashi-Kanagawa Store” and never visited the supermarket “CC shop Higashi-Kanagawa Store”. In this case, when the user is absent from home, a package is delivered to the convenience store “AA Mart Higashi-Kanagawa Store” and the convenience store “AA Mart Higashi-Kanagawa Store” stores the package. The user will be willing to head to the convenience store “AA Mart Higashi-Kanagawa Store” to receive the package.

The method for setting user area information according to the present embodiment has been conceived as a result of the above examination. First, movement history information indicating a history of current positions of a user, which correspond to the above X's. The current positions of the user are current positions of a user terminal used by the user. Storage locations within the second distance D2 from positions at which the user has been located are identified by the movement history information regarding the user. Information indicating, among the identified storage locations, ones frequently visited by the user are then set as user area information indicating delivery location candidates for the user. FIG. 8 illustrates a specific processing flow of the method for setting user area information.

A case will be described with reference to FIG. 8 where the server 1 sets user area information regarding a user and then notifies a user terminal 2 used by the user that the setting of the user area information has been completed. The server 1 also sets user area information regarding other users for whom packages are to be delivered by the delivery vehicle 4 in accordance with the flowchart of FIG. 8 and then notifies user terminals 2 used by the other users that the setting of the user area information regarding the other users has been completed.

As illustrated in FIG. 8, the communication unit 12 receives a user ID and second positional information indicating a current position of a target user, that is, a current position of a user terminal (step S21), both of which have been transmitted from the user terminal 2 in step S1 (FIG. 3). The control unit 11 associates the user ID and the second positional information received in step S21 with each other and stores the user ID and the second positional information in the movement history table Tuh illustrated in FIG. 9 (step S22).

Alternatively, presence of a user may be detected at stores such as convenience stores and post offices from images obtained by monitoring cameras, sounds obtained by monitoring microphones, and purchase histories of products. Alternatively, presence of a user may be detected at stations from use histories of automated fare collection gates. Information indicating a position of a store, a station, or the like at which presence of a user has been detected may be transmitted to the server 1 as second positional information along with a user ID for identifying the user. In this case, too, the server 1 may perform step S22 and later steps using the user ID and the second positional information received by the communication unit 12.

The movement history table Tuh is part of a storage area of the memory 13. Second positional information indicating current positions of each of one or more users is stored in the movement history table Tuh as records. That is, one or more records corresponding to each of the one or more users stored in the movement history table Tuh are an example of movement history information indicating a history of current positions of the user.

More specifically, as illustrated in FIG. 9, the movement history table Tuh includes fields of “time”, “user ID”, “positional information”, “area ID”, and “total number of visits”. In step S22, the control unit 11 stores, in the “time” field, a time (an example of a reception time; e.g., “8:00”) at which the user ID and the second positional information have been received in step S21. Although information indicating an hour and a minute (e.g., “8:00”) are indicated in the “time” field in FIG. 9 for the convenience of description, information indicating a year, a month, and a date (e.g., “12/10/2018”) is also stored in practice.

The control unit 11 stores the user ID (e.g., “GUEST0020”) received in step S21 in the “user ID” field. The control unit 11 stores the second positional information (e.g., “35.478898, 139.635775”) received in step S21 in the “positional information” field. By storing the user ID and the second positional information received in step S21 in the “user” ID field and the “positional information” field, respectively, of the movement history table Tuh, the control unit 11 stores the user ID and the second positional information received in step S21 in the memory 13 while associating the user ID and the second positional information with each other.

In the “area ID” field, an area ID for identifying a storage location within the second distance D2 from a position indicated by the second positional information stored in the “positional information” field is stored as described later. In the “total number of visits” field, the total number of visits by the user identified by the user ID stored in the “user ID” field at the storage locations identified by the area IDs stored in the “area ID” field is stored as described later.

After step S22, the control unit 11 determines, using the area table Tmh1 illustrated in FIG. 10, whether there is a storage location capable of storing packages within the second distance D2 from the position indicated by the second positional information received in step S21 (step S23). The second distance D2 is, for example, the radius of a circle large enough to cover a site of a storage location (e.g., 20 to 300 m).

The area table Tmh1 is part of the storage area of the memory 13. Information (an example of area information) indicating one or more storage locations capable of storing packages is stored on the area table Tmh1 in advance. More specifically, as illustrated in FIG. 10, the area table Tmh1 includes fields of “area ID”, “name”, and “area positional information”. The “area ID” field stores area IDs (e.g., “CB0011”) for identifying storage locations capable of storing packages. The “name” field stores names (e.g., “AA Mart Higashi-Kanagawa Store”) of storage locations. The “area positional information” field stores area positional information (e.g., “(35.67971, 139.765125)”) indicating the latitude and longitude of storage locations. The area positional information is not limited to this type of information but may be information indicating addresses (state, city, and lot number), of storage locations, instead.

More specifically, in step S23, the control unit 11 determines whether the area table Tmh1 stores area positional information indicating a position within the second distance D2 from the position indicated by the second positional information received in step S21. If so, the control unit 11 determines that there is a storage location within the second distance D2 from the position indicated by the second positional information received in step S21 (YES in step S23). In this case, the control unit 11 stores an area ID for identifying the storage location and the second positional information stored in the movement history table Tuh in step S22 while associating the area ID and the second positional information with each other (step S24). The control unit 11 thus stores the area ID for identifying the storage location as part of movement history information indicating a history of current positions of the target user while assuming that the target user has visited the storage location.

More specifically, in step S24, the control unit 11 obtains an area ID (e.g., “CB0011”) associated on the area table Tmh1 illustrated in FIG. 10 with area positional information (e.g., “(35.67971, 139.765125)”) indicating a position within the second distance D2 from the position indicated by the second positional information received in step S21. The control unit 11 then stores the obtained area ID (e.g., “CB0011”) in the “area ID” field of the movement history table Tuh while associating the area ID with the second positional information (e.g., “(35.67971, 139.765125)”) stored in the “positional information” field of the movement history table Tuh (FIG. 9).

It is assumed that the area table Tmh1 stores area positional information indicating positions within the second distance D2 from the position indicated by the second positional information received in step S21. In this case, in step S24, the control unit 11 stores an area ID included in a record including area positional information indicating a position closest to the position indicated by the second positional information while associating the area ID with the second positional information stored in the movement history table Tuh in step S22.

Next, the control unit 11 increments, in the movement history information regarding the target user stored in the movement history table Tuh, a maximum value of the total number of visits associated with the area ID stored in step S24 (step S25). The control unit 11 thus increments the total number of visits, which is the number of times that the target user has visited the storage location identified by the area ID stored in the movement history table Tuh in step S24.

For example, the movement history table Tuh illustrated in FIG. 9 indicates an example in which, after the communication unit 12 received a user ID “GUEST0020” and second positional information “(35.480165, 139.639302)” at a time “8:05”, an area ID “CB0011” was stored in the “area ID” field in step S24 and then step S25 was performed.

That is, in this specific example, the control unit 11 refers to one or more records associated on the movement history table Tuh with the user ID “GUEST0020”, the one or more records being movement history information regarding the target user identified by the user ID “GUEST0020”. The control unit 11 then refers to, among the one or more records, a record whose rea ID is the area ID “CB0011”, which has been stored in step S24, and whose total number of visits is the maximum value “80”. The control unit 11 then stores, in the “total number of visits” field associated with the area ID “CB0011” stored in step S24, a result “81” obtained by adding 1 to the maximum value “80” of the total number of visits stored in the “total number of visits” of the record.

Next, the control unit 11 determines whether the movement history information regarding the target user identified by the user ID received in step S21 includes a record whose total number of visits is larger than a first certain value (step S26). If so (YES in S26), the control unit 11 performs step S27.

In step S27, the control unit 11 stores an area ID included in the record whose total number of visits is larger than the first certain value in the customer table Tcs illustrated in FIG. 11 while associating the area ID with the user ID received in step S21 (step S27). If the record whose total number of visits is larger than the first certain value includes area IDs different from one another, the control unit 11 stores the area IDs in the customer table Tcs illustrated in FIG. 11.

On the customer table Tcs illustrated in FIG. 11, one or more area IDs corresponding to each user ID are user area information regarding a user identified by the user ID. For example, user area information regarding a user identified by the user ID “GUEST0020” on the customer table Tcs illustrated in FIG. 11 is CB0011, CB0012, and LK0080.

Area IDs stored in the customer table Tcs may be referred to as “user area IDs”. That is, the control unit 11 stores, in the memory 13, one or more area IDs for identifying one or more storage locations that have been visited by a target user a number of times more than the first certain value as one or more user area IDs for identifying one or more delivery location candidates for the target user. User area information regarding a target user is one or more user area IDs of the target user.

The control unit 11 thus ends the setting of user area information regarding a target user.

The customer table Tcs is part of the storage area of the memory 13. The customer table Tcs stores in advance information regarding users who use the presentation system 10. More specifically, as illustrated in FIG. 11, the customer table Tcs includes fields of “user ID”, “name”, “home address”, “home position”, and “user area ID”. The “user ID” field stores user IDs (e.g., “GUEST0020”) for identifying users. The “name” field stores names of users (e.g., “Taro Takkyu”). The “home address” field stores addresses of users' homes. The “home position” field stores home positional information (e.g., “(35.477963, 139.633347)”) indicating the latitude and longitude of positions of users' homes.

The “user area ID” field stores user area information regarding users. User area information regarding a user is one or more user area IDs for identifying one or more delivery location candidates. That is, in step S27, the control unit 11 stores, in the “user area ID” field, an area ID included in the record whose total number of visits is determined in step S26 to be larger than the first certain value. Alternatively, the control unit 11 may store, in the “user area ID” field, an area ID included in a record whose total number of visits is determined to be larger than the first certain value and another area ID that is different from the foregoing area ID and that is included in another record whose total number of visits is determined to be larger than the first certain value.

For example, the customer table Tcs illustrated in FIG. 11 indicates an example in which it has been determined in step S26 that the movement history information regarding the target user identified by the user ID “GUEST0020” includes first to third records whose total number of visits is larger than the first certain value, and, in step S27, the area ID “CB0011” included in the first record, the area ID “CB0012” included in the second record, and the area ID “LK0080” included in the third record have been stored in the “user area ID” field.

Instead of performing steps S25 to S27, the control unit 11 may refer to one or more records of the movement history table Tuh indicating the movement history information regarding the target user identified by the user ID received in step S21. The control unit 11 may then obtain one or more area IDs, the number of which is larger than the first certain value, included in the one or more records. Lastly, the control unit 11 may, as in step S27, store the obtained one or more area IDs in the customer table Tcs as one or more user area IDs for identifying one or more delivery location candidates indicated by the user area information regarding the target user.

After step S27, the control unit 11 causes the communication unit 12 to transmit, to the user terminal 2 used by the target user, information (hereinafter referred to as “setting completion information”) indicating that the setting of user area information has been completed (step S28).

The setting completion information includes information indicating names and a position of the delivery location candidate identified by the user area ID stored in the customer table Tcs in step S27, information indicating a map image of a certain range including the target user's home and the delivery location candidate identified by the user area ID, and information indicating the position of the target user's home stored in the “home position” field of the customer table Tcs. The control unit 11 obtains a name of a storage location and area positional information associated in the area table Tmh1 with the same area ID as the user area ID as information indicating the name and the position of the delivery location candidate identified by the user area ID. The map image may be image data indicating the map data or a uniform resource locator (URL) for accessing the image data.

The communication unit 25 of the user terminal 2 used by the target user receives setting completion information, and the control unit 21 displays, on the display unit 26, the notification screen G120 indicating the setting completion information received by the communication unit 25 as illustrated in FIG. 12.

The notification screen G120 includes a map area R121 and a message area R122. The control unit 21 displays, in the map area R121, the map image included in the setting completion information. The control unit 21 obtains the information indicating a position of a delivery location candidate included in the setting completion information and displays a mark M121 indicating the delivery location candidate at a position on the map image corresponding to the position indicated by the obtained information. The control unit 21 also obtains information indicating a position of a target user's home included in the setting completion information and displays a mark M122 indicating the target user's home at a position on the map image corresponding to the position indicated by the obtained information. The message area R122 includes a display field F121. The control unit 21 displays, in the display field F121, the name (e.g., “AA Mart Higashi-Kanagawa Store”) of the delivery location candidate included in the setting completion information.

According to this mode, one or more area IDs included in movement history information regarding a target user are stored in the memory 13 as user area IDs, the number of which is larger than the first certain value, indicated by user area information regarding the target user. As a result, information indicating storage locations estimated to have been visited by the target user a number of times more than the first certain value is determined as user area information regarding the target user. When alternative information is transmitted to a user terminal 2 used by the target user in step S7 (FIG. 3), therefore, the target user is notified that a package can be delivered to alternative delivery locations frequently visited by the target user.

Use Case 1: Processing Flow when User is Absent

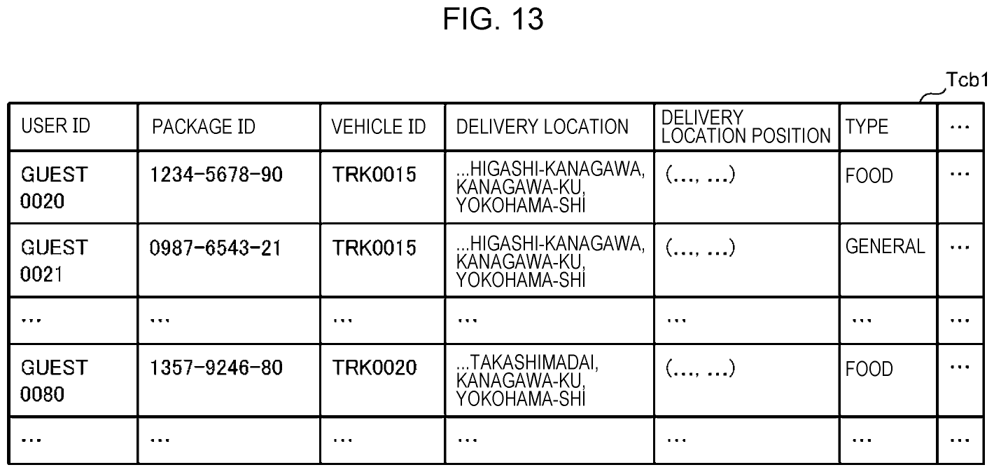

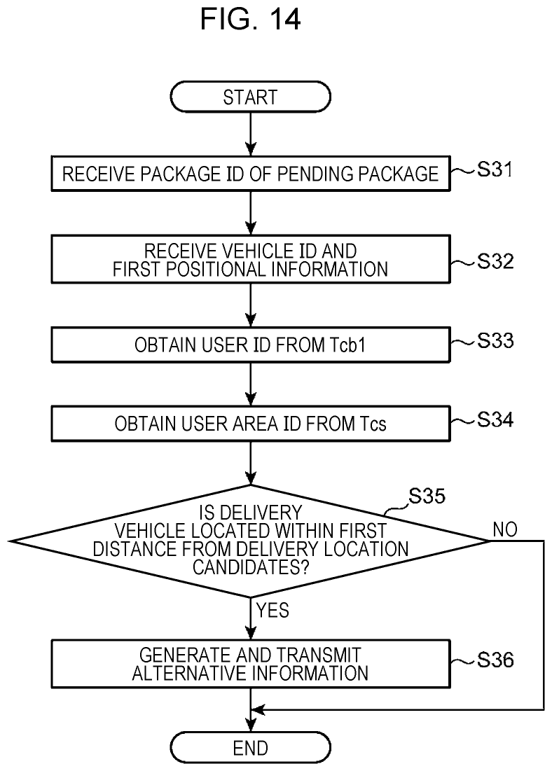

Even when information indicating a delivery location of a package for each user is displayed on the delivery terminal 3 in accordance with the sequence illustrated in FIG. 3 while the delivery vehicle 4 is running, the package might be delivered, without performing step S10, to a delivery location specified by the user. In this case, the user might be absent when the delivery vehicle 4 arrives at the delivery location. A mode (hereinafter referred to as “use case 1”) in which information indicating a delivery location of a package for a user is displayed on the delivery terminal 3 when the user is absent will be described hereinafter with reference to FIGS. 13 and 14. FIG. 13 is a diagram illustrating an example of a package table Tcb1. FIG. 14 is a flowchart illustrating a first example of a process performed by the server 1 when the user is absent.

It is assumed in the following description that, as described above, the process illustrated in FIG. 8 has been performed to set user area information regarding each of one or more users. It is also assumed that the server 1 has created in advance, for delivery vehicles 4 managed thereby, a package list (an example of package information), which is information regarding packages for one or more users to be delivered by the delivery vehicles 4, and the package list is stored in advance in the package table Tcb1 illustrated in FIG. 13.

It is also assumed that the package list corresponding to the delivery vehicle 4 in the presentation system 10 stored in the package table Tcb1 is transmitted from the server 1 to the delivery terminal 3 before the delivery vehicle 4 leaves a delivery center, and the memory 32 of the delivery terminal 3 stores the package list received from the server 1.

The package table Tcb1 is part of the storage area of the memory 13. More specifically, as illustrated in FIG. 13, the package table Tcb1 includes fields of “user ID”, “package ID”, “vehicle ID”, “delivery ID”, “delivery location”, “delivery location position”, and “type”. The “user ID” field stores user IDs (e.g., “GUEST0020”) for identifying users. The “package ID” field stores package IDs (e.g., “1234-5678-90”) for identifying packages for users. The “vehicle ID” field stores vehicle IDs (e.g., “TRK0015”) for identifying delivery vehicles 4 that deliver packages for users.

The “delivery location” field stores delivery location name information (e.g., “ . . . Higashi-Kanagawa, Kanagawa-ku, Yokohama-shi”) indicating names or addresses of delivery locations of packages originally specified by users. The “delivery location position” field stores delivery location positional information (e.g., “( . . . , . . . )”) indicating the latitude and longitude of positions of delivery locations of packages originally specified by users. The delivery location name information and the delivery location positional information together constitute delivery location information indicating delivery locations of packages originally specified by users. The “type field” stores attribute information (e.g., “food”) indicating types of package for users. One or more records stored in the package table Tcb1 correspond to the package list.

In use case 1, first, a driver of a delivery vehicle 4 inputs, using the operation unit 33 of the delivery terminal 3, a package ID for identifying a package (hereinafter referred to as an “pending package”) for a user who is absent from a specified delivery location. When the package ID for identifying the pending package is input, the control unit 31 causes the communication unit 35 to transmit the input package ID for identifying the pending package to the server 1.

As illustrated in FIG. 14, the communication unit 12 of the server 1 receives the package ID for identifying the pending package from the delivery terminal 3 (step S31) and also receives, from the delivery terminal 3, a vehicle ID and first positional information periodically transmitted from the delivery terminal 3 in step S4 (refer to FIG. 3) (step S32). The control unit 11 refers to the package table Tcb1 (FIG. 13) and obtains a user ID (e.g., “GUEST0020”) associated with the package ID (e.g., “1234-5678-90”) received in step S31 (step S33).

Next, the control unit 11 obtains, from the customer table Tcs (FIG. 11), one or more user area IDs (e.g., “CB0011”, “CB0012”, and “LK0080”) associated with the user ID (e.g., “GUEST0020”) received in step S33 (step S34). The control unit 31 thus obtains, in steps S33 and S34, one or more user area IDs for identifying one or more delivery location candidates indicated by user area information regarding the user to whom the pending package is to be delivered.

Next, as in step S5 (FIG. 3), the control unit 11 performs a process for comparing one or more areas that are in one-to-one correspondence with positions of the one or more delivery location candidates indicated by the one or more user area IDs obtained in step S34 with a current position P1 of the delivery vehicle 4 indicated by the first positional information received in step S32 (step S35). Each of the one or more areas is an area within the first distance D1 from a position of a corresponding delivery location candidate. More specifically, the control unit 11 obtains one or more pieces of area positional information associated on the area table Tmh1 (FIG. 10) with the same area IDs as the one or more user area IDs obtained in step S34 and performs the comparison process in step S35 while determining one or more positions indicated by the obtained one or more pieces area positional information as the positions of the one or more delivery location candidates.

It is assumed that one or more of the one or more areas that are in one-to-one correspondence with the one or more user area IDs obtained in step S34 include the current position P1 of the delivery vehicle 4 (YES in step S35). The one or more areas that are in one-to-one correspondence with the one or more user area IDs obtained in step S34 may be referred to as “third one or more areas”, and the one or more of the third one or more areas including the current position P1 of the delivery vehicle 4 may be referred to as “fourth one or more areas”.

In this case, as in steps S6 and S7 (FIG. 3), the control unit 11 generates alternative information and causes the communication unit 12 to transmit the generated alternative information to a user terminal 2 used by the user identified by the user ID obtained in step S33 (step S36). As a result, the user is notified that the package can be delivered to one or more alternative delivery locations, which are one or more delivery location candidates that are in one-to-one correspondence with the fourth one or more areas associated with positions that have been visited by the user identified by the user ID obtained in step S33. The one or more delivery location candidates corresponding to the fourth one or more areas and the one or more alternative delivery locations are in one-to-one correspondence. Step S8 and the later steps illustrated in FIG. 3 will be performed thereafter.

More specifically, in step S36, the control unit 11 generates, as alternative information, information including the package ID received in step S31, the one or more of the one or more user area IDs obtained in step S34 that identify the one or more alternative delivery locations, and names of one or more storage locations associated on the area table Tmh1 (FIG. 10) with the same area IDs as the one or more user areas for identifying the one or more alternative delivery locations.

It is assumed, on the other hand, that, as a result of the comparison process performed in step S35, none of the areas within the first distance D1 from positions of all the delivery location candidates indicated by the one or more user area IDs obtained in step S34 includes the current position P1 of the delivery vehicle 4. That is, it is assumed that the delivery vehicle 4 is located at a position more than the first distance D1 away from any of the positions of delivery location candidates indicated by the one or more user area IDs obtained in step S34 (NO in step S35), on the other hand, the control unit 11 ends the process without performing step S36. In this case, step S8 and the later steps illustrated in FIG. 3 are not performed either.

Step S10 (FIG. 3) is then performed. If the server 1 receives delivery location information indicating one of the one or more alternative delivery locations from the user terminal 2 used by the user, the server 1 transmits, in step S11 (FIG. 3) to the delivery terminal 3 provided for the delivery vehicle 4, presentation information indicating that the package for the user is to be delivered to the alternative delivery location indicated by the delivery location information. As a result, the driver of the delivery vehicle 4 is notified that the pending package is to be delivered to the alternative delivery location that is located within the first distance D1 from the current position P1 of the delivery vehicle 4 and that is estimated to have been visited by the user. The driver of the delivery vehicle 4, therefore, can deliver the pending package to the alternative delivery location that is familiar and convenient for the user to receive the package if the driver moves the delivery vehicle 4 at a distance of the first distance at most, thereby preventing redelivery.

### Use Case 2: Processing Flow Before Delivery Vehicle 4 Starts

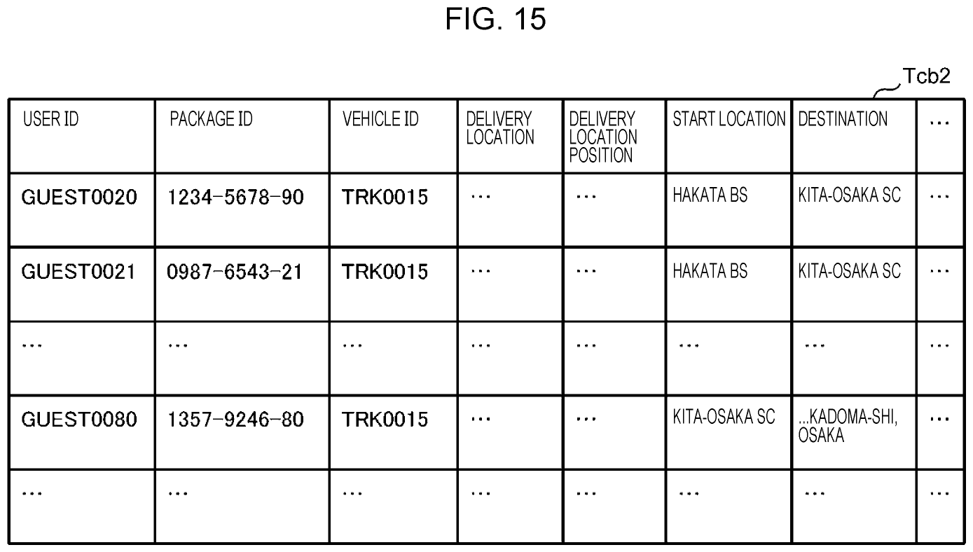

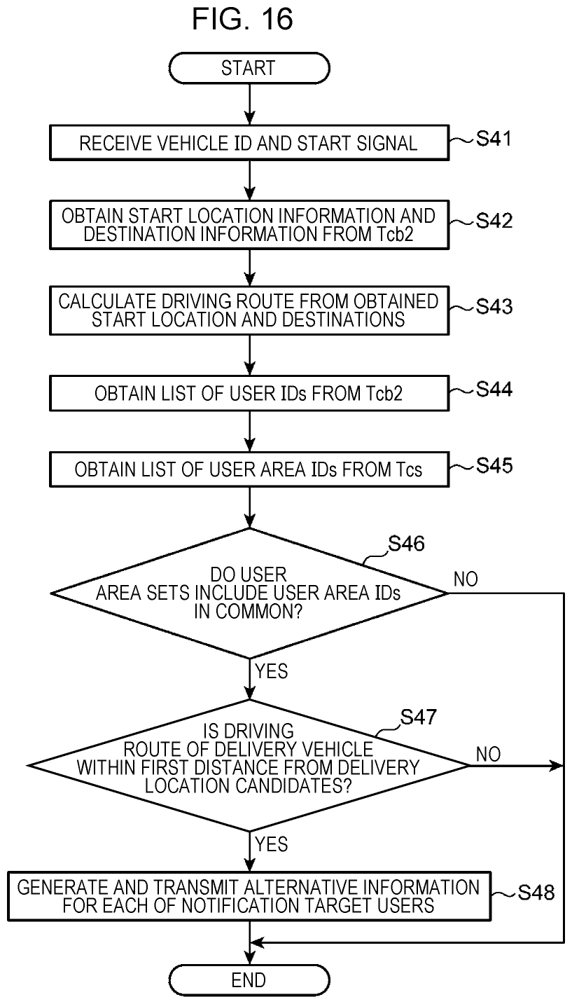

When the delivery vehicle 4 delivers packages for users who live close to one another, the delivery vehicle 4 can efficiently deliver the packages without individually delivering the packages if the delivery vehicle 4 delivers the packages for the users to a storage location near the users' homes. A mode (hereinafter referred to as “use case 2”) in which information indicating delivery locations of packages for users is displayed on the delivery terminal 3 before a delivery vehicle 4 that delivers the packages starts will be described hereinafter with reference to FIGS. 15 and 16. FIG. 15 is a diagram illustrating an example of a package table Tcb2. FIG. 16 is a flowchart illustrating a first example of a process performed by the server 1 before the delivery vehicle 4 starts.

It is assumed in the following description that, as described above, the process illustrated in FIG. 8 has been performed to set user area information regarding each of users. It is also assumed that the server 1 has created in advance a package list having a configuration different from that in use case 1 and the package list is stored in the package table Tcb2 illustrated in FIG. 15 in advance.

The package table Tcb2 is part of the storage area of the memory 13. More specifically, as illustrated in FIG. 15, the package table Tcb2 includes, as with the package table Tcb1 illustrated in FIG. 13, fields of “user ID”, “package ID”, “vehicle ID”, “delivery location”, and “delivery location position”. The package table Tcb2 further includes fields of “start location” and “destination”.

The “start location” field stores start location information (e.g., “Hakata BS”) indicating start locations at a time when the delivery vehicle 4 delivers packages to users identified by user IDs stored in the “user ID” field. The “destination field” stores destination information (e.g., “Kita-Osaka SC”) indicating destinations at a time when the delivery vehicle 4 delivers packages to users identified by user IDs stored in the “user ID” field. One or more records stored in the package table Tcb2 correspond to the package list.

Although start location information is names of start locations (e.g., “Hakata BS”) in FIG. 15 for convenience of description, start location information also includes information indicating the latitude and longitude of positions of the start locations in practice. Similarly, destination information includes information indicating names of destinations and the latitude and longitude of positions of the destinations.

In use case 2, first, the driver of the delivery vehicle 4 inputs, using the operation unit 33 of the delivery terminal 3, at the start location, a signal (hereinafter referred to as a “start signal”) indicating that the delivery vehicle 4 is about to start. Upon receiving the start signal, the control unit 31 causes the communication unit 35 to transmit the input start signal to the server 1 along with the vehicle ID stored in the memory 32.

As illustrated in FIG. 16, the communication unit 12 of the server 1 receives the vehicle ID and the start signal from the delivery terminal 3 (step S41), and the control unit 11 refers to the package table Tcb2 (FIG. 15) and obtains one or more pieces of start location information (e.g., “Hakata BS”, “Hakata BS”, “Kita-Osaka SC”, etc.) and one or more pieces of destination information (e.g., “Kita-Osaka SC”, “Kita-Osaka SC”, “ . . . Kadoma-shi, Osaka”, etc.) associated with the vehicle ID (e.g., “TRK0015”) received in step S41 (step S42).

Next, the control unit 11 calculates, through a known process for finding a route usually performed by automotive navigation systems and the like, a driving route used by the delivery vehicle 4 until the delivery vehicle 4 finishes delivering a final package after delivering a first package on the basis of positions of one or more start locations indicated by the one or more pieces of start location information and positions of one or more destinations indicated by the one or more pieces of destination information obtained in step S42 (step S43).

It is assumed, for example, that the vehicle ID “TRK0015” is received in step S41 and steps S42 and S43 are performed using the package table Tcb2 illustrated in FIG. 15. In this case, in step S43, a driving route connecting a start location “Hakata BS”, from which the delivery vehicle 4 starts to deliver a first package to a user identified by a user ID “GUEST0020” to a destination “ . . . Kadoma-shi, Osaka”, which is a destination at a time when the delivery vehicle 4 delivers a package to a user identified by a user ID “GUEST0080” via a start location “Kita-Osaka SC”, which is a destination at a time when the delivery vehicle 4 delivers the first package and from which the delivery vehicle 4 starts to deliver the package to the user identified by the user ID “GUEST0080”.

The control unit 11 also refers to the package table Tcb2 (FIG. 15) and obtains one or more user IDs (e.g., “GUEST0020”, “GUEST0021”, “GUEST0080”, etc.) associated with the vehicle ID (e.g., “TRK0015”) received in step S41 (step S44). The control unit 11 then obtains, from the customer table Tcs (FIG. 11), one or more user area IDs (e.g., one or more user area IDs “CB0011”, “CB0012”, and “LK0080” associated with the user ID “GUEST0020”, one or more user area IDs “CB0011”, “CB0012”, and “LK0080” associated with the user ID “GUEST0021”, one or more user area IDs “CB0030” and “LK0090” associated with the user ID “GUEST0080”, etc.) associated with the one or more user IDs received in step S44 (step S45). The control unit 11 thus obtains, in steps S44 and S45, one or more user area IDs for identifying one or more delivery candidate locations indicated by user area information regarding users for whom one or more packages to be delivered by a delivery vehicle 4 before the delivery vehicle 4 starts.

Next, the control unit 11 determines whether a user area set including one or more user area IDs that have been obtained in step S45 and that are associated with a user and a user area set including one or more user area IDs that have been obtained in step S45 and that are associated with another user include any user area IDs in common (step S46). It is assumed, for example, that the user area IDs “CB0011”, “CB0012”, and “LK0080” associated with the user ID “GUEST0020” and the user area IDs “CB0011” and “LK0080” associated with the user ID “GUEST0021” have been obtained in step S45 from the customer table Tcs illustrated in FIG. 11. In this case, the control unit 11 determines in step S46 that the two user area sets include the user area ID “CB0011” in common. The control unit 11 also determines in step S46 that the two user area sets include the user area ID “LK0080” in common. The one or more user area IDs included in the two user area sets in common are “CB0011” and “LK0080”.

Next, the control unit 11 compares, as in step S35 (FIG. 14), one or more areas that are in one-to-one correspondence with positions of one or more delivery location candidates (an example of one or more common candidates) indicated by the one or more user area IDs determined in step S46 to be included in common with the driving route of the delivery vehicle 4 calculated in step S43 (step S47). Each of the one or more areas is an area within the first distance D1 from a position of a corresponding delivery location candidate. That is, the control unit 11 determines in step S47 whether the delivery vehicle 4 can easily deliver packages with the driving route calculated in step S43, that is, whether there are one or more common delivery locations within the first distance D1 from the driving route.

It is assumed in step S47 that one or more of the one or more areas that are in one-to-one correspondence with the one or more user area IDs determined in step S46 to be included in common include a position on the driving route of the delivery vehicle 4 calculated in step S43 (YES in step S47). The one or more areas that are in one-to-one correspondence with the one or more user area IDs determined in step S46 to be included in common may be referred to as “fifth one or more areas”, and the one or more of the fifth one or more areas including a position on the driving route of the delivery vehicle 4 may be referred to as “sixth one or more areas”.

In this case, the control unit 11 performs step S48, which is the same as step S36 (FIG. 14), on each of one or more notification target users corresponding to user area information including the one or more user area IDs for identifying one or more delivery location candidates (hereinafter referred to as “one or more common delivery locations”) that are in one-to-one correspondence with the sixth one or more areas (step S48). More specifically, in step S48, the control unit 11 generates alternative information for determining the one or more common delivery locations indicated by the one or more user area IDs included in the user area information regarding each of the notification target users as one or more alternative delivery locations. The control unit 11 then causes the communication unit 12 to transmit the generated alternative information to each of user terminals 2 used by the notification target users. Step S8 and the later steps illustrated in FIG. 3 will be performed thereafter.

It is assumed, for example, that, in step S47, an area within the first distance D1 from a position of a common delivery location indicated by the user area ID “CB0012” includes a position on the driving route of the delivery vehicle 4 and an area within the first distance D1 from a position of a common delivery location indicated by the user area ID “LK0080” includes a position on the driving route of the delivery vehicle 4. In this case, the control unit 11 determines, in step S48, that the user identified by the user ID “GUEST0020” associated on the customer table Tcs illustrated in FIG. 11 with the user area IDs “CB0012” and “KJ0080” as a notification target user.

The control unit 11 then generates, as alternative information, information including the package ID “1234-5678-90” associated on the package table Tcb2 (FIG. 15) with the user ID “GUEST0020” for identifying the notification target user, the user area IDs “CB0012” and “LK0080” for identifying the two common delivery locations, and names “CC shop Higashi-Kanagawa Store” and “Higashi-Kanagawa Station Lockers” of storage locations associated on the area table Tmh1 (FIG. 10) with the same area IDs as the user area IDs “CB0012” and “LK0080” for identifying the two common delivery locations. The control unit 11 then causes the communication unit 12 to transmit the generated alternative information to the user terminal 2 used by the notification target user.

The control unit 11 also determines a user identified by the user ID “GUEST0021” associated on the customer table Tcs illustrated in FIG. 11 with, between the user area IDs “CB0012” and “LK0080” for identifying the two common delivery location, the user area ID “LK0080” as a notification target user.

The control unit 11 then generates, as alternative information, information including a package ID “0987-6543-21” associated on the package table Tcb2 (FIG. 15) with the user ID “GUEST0021” for identifying the notification target user, the user area ID “LK0080” for identifying one of the two common delivery locations, and the name “Higashi-Kanagawa Station Lockers” of the storage location associated on the area table Tmh1 (FIG. 10) with the same area ID as the user area ID “LK0080” for identifying one of the two common delivery locations. The control unit 11 causes the communication unit 12 to transmit the generated alternative information to the user terminal 2 used by the notification target user.

According to this mode, if a user area set including one or more user area IDs associated with a user and a user area set including one or more user area IDs associated with another user include one or more user area IDs in common, fifth one or more areas within the first distance D1 from positions of one or more delivery location candidates that are in one-to-one correspondence with the one or more user areas included in common are compared with positions on a driving route used by the delivery vehicle 4 until the delivery vehicle 4 finishes delivering a final package after starting delivering a first package. Each of the fifth one or more areas is an area within the first distance D1 from a position of a corresponding delivery location candidate. It is assumed that, as a result of the comparison, sixth one or more areas among the fifth one or more areas include a position on the driving route. In this case, alternative information for determining one or more common delivery locations indicated by one or more user area IDs that are in one-to-one correspondence with the sixth one or more areas as one or more alternative delivery locations is transmitted to the user terminals 2 used by the notification target users.

As a result, if there are one or more common delivery locations within the first distance D1 from a driving route, notification target users are notified that packages can be delivered to the one or more common delivery locations. Since presentation information is transmitted to the delivery terminal 3 if delivery location information is received from user terminals 2 used by the one or more notification target users, the delivery vehicle 4 can deliver all the packages for the one or more notification target users to one of the one or more common delivery locations indicated by the received delivery location information. In this case, the delivery vehicle 4 can efficiently deliver the packages since the delivery vehicle 4 need not individually deliver the packages for the notification target users to specified delivery locations.

### Use Case 3: Processing Flow Before Delivery Vehicle 4 Starts

It might become difficult for a user to move to a delivery location of a package before a delivery time specified in advance due to urgent business or the like. If a storage location estimated to have been frequently visited by the user is near a driving route of a delivery vehicle 4 in this case, the delivery vehicle 4 may deliver the package to the storage location. In doing so, a driver of the delivery vehicle 4 can deliver the package without driving the delivery vehicle 4 to the delivery location originally specified by the user. As a result, fuel cost of the delivery vehicle 4 and time taken to deliver the package can be reduced. In addition, the user can receive the package at the storage location frequently visited thereby at a convenient time without hurrying to the delivery location.

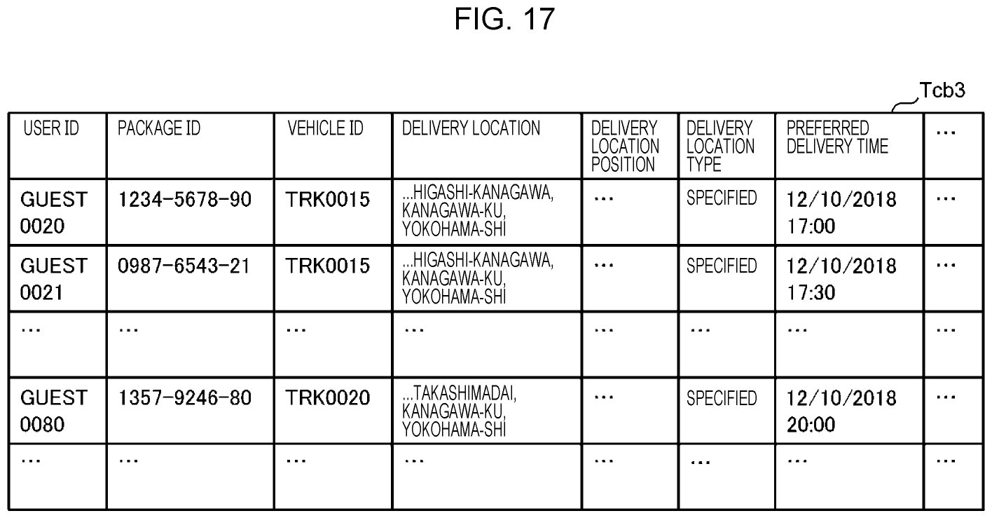

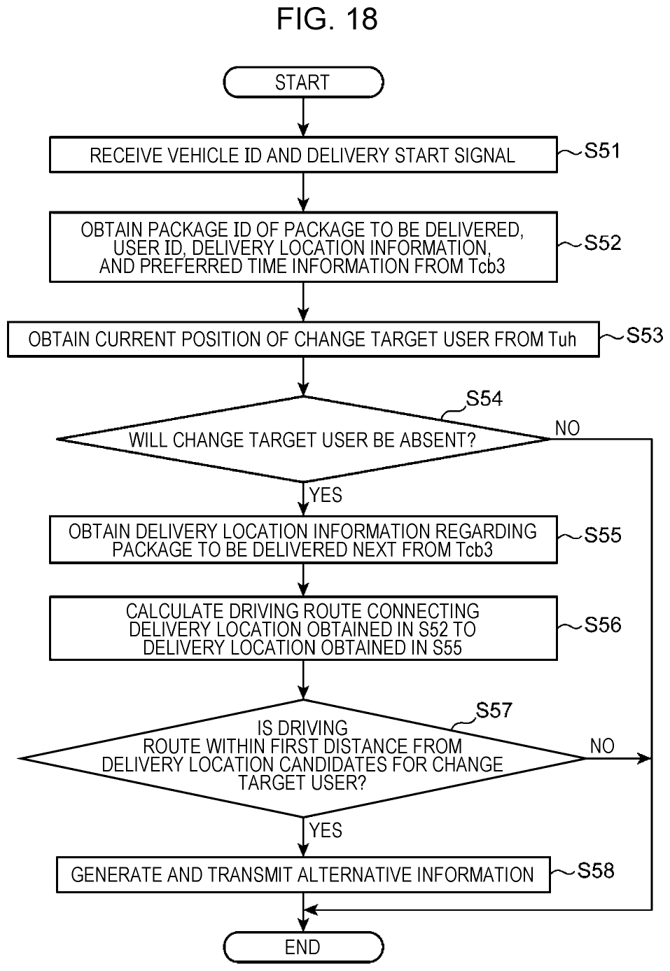

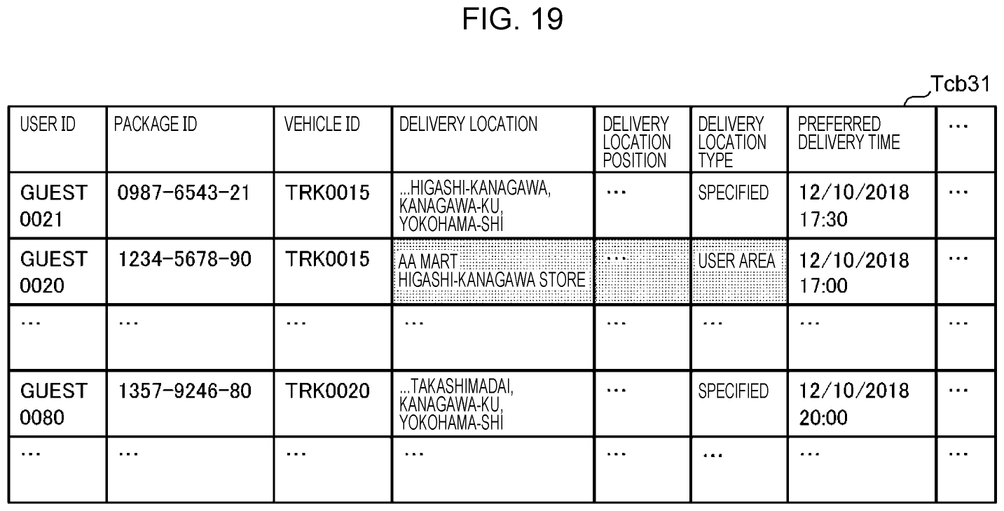

A mode (hereinafter referred to as “use case 3”) in which information indicating a delivery location of a package for a user is displayed, before the delivery vehicle 4 starts to deliver the package, on the delivery terminal 3 on the basis of a current position of a user to whom the package is to be delivered, a preferred delivery time specified by the user, and a delivery location originally specified by the user will be described hereinafter with reference to FIGS. 17 to 19. FIG. 17 is a diagram illustrating an example of a package table Tcb3. FIG. 18 is a flowchart illustrating a second example of the process performed by the server 1 before the delivery vehicle 4 starts. FIG. 19 is a diagram illustrating an example of the package table Tcb3 after the process illustrated in FIG. 18 is performed.

It is assumed in the following description that, as described above, the process illustrated in FIG. 8 is performed to set user area information regarding each of one or more users. It is also assumed that the server 1 has created a package list having a configuration different from those in use cases 1 and 2 and the package list is stored in the package table Tcb3 illustrated in FIG. 17 in advance.

In use case 3, as illustrated in FIG. 17, the package table Tcb3 includes fields of “user ID”, “package ID”, “vehicle ID”, “delivery location”, and “delivery location position” as with the package table Tcb1 illustrated in FIG. 13. The package table Tcb3 also includes fields of “delivery location type” and “preferred delivery time”.

The “delivery location type” field stores “specified” (hereinafter referred to as “third information”), which indicates that a delivery location indicated by delivery location information including delivery location name information and delivery location positional information stored in the “delivery location” and “delivery location position” fields, respectively, is a location originally specified by a user when the user has requested delivery of a package. The third information is stored in the “delivery location type” field when the package list is created, but the third information stored in the “delivery location type” field might be updated, as a result of the process performed by the server 1 in accordance with the processing flow illustrated in FIG. 18, to “user area” (hereinafter referred to as “fourth information”), which indicates a location determined on the basis of user area information regarding a user. The “preferred delivery time” field stores preferred delivery time information, which indicates preferred delivery times specified by the users.

One or more records stored in the package table Tcb3 correspond to the package list. The one or more records corresponding to the package list are sorted in order of delivery along a driving route of the delivery vehicle 4 determined on the basis of the delivery location information stored in the “delivery location” and “delivery location position” fields using a known process for finding a shortest route usually performed by automotive navigation systems and the like. The package table Tcb3 illustrated in FIG. 17 indicates, for example, that a package identified by a package ID “1234-5678-90” included in a first record is to be delivered first and a package identified by a package ID “0987-6543-21” included in a second record is to be delivered next.

In use case 3, first, the driver of the delivery vehicle 4 inputs, using the operation unit 33 of the delivery terminal 3, a signal (hereinafter referred to as a “delivery start signal”) indicating that the delivery vehicle 4 is about to start to deliver a package. Upon receiving the delivery start signal, the control unit 31 causes the communication unit 35 to transmit the input delivery start signal and the vehicle ID stored in the memory 32 to the server 1.

As illustrated in FIG. 18, the communication unit 12 of the server 1 receives the vehicle ID and the delivery start signal from the delivery terminal 3 (step S51), and the control unit 11 refers to the package table Tcb3 (FIG. 17) and obtains, among one or more package IDs associated with the vehicle ID (e.g., “TRK0015”) received in step S51, a package ID (e.g., “1234-5678-90”) for identifying the package to be delivered, a user ID (e.g., “GUEST0020”), delivery location information (e.g., delivery location name information “ . . . Higashi-Kanagawa, Kanagawa-ku, Yokohama-shi” and delivery location positional information “ . . . ”), and preferred delivery time information (e.g., “12/10/2018” 17:00) associated with the package ID (step S52).

Next, the control unit 11 obtains, from the movement history table Tuh (FIG. 9), information indicating a current position of a user (hereinafter referred to as a “change target user”) identified by the user ID obtained in step S52 (step S53). More specifically, in step S53, the control unit 11 obtains positional information (e.g., “(35.606218, 139.734931)”) stored in the “positional information” field of a last one of one or more records including the user ID (e.g., “GUEST0020”) obtained in step S52 stored in the movement history table Tuh (FIG. 9) as information indicating the current position of the change target user.

Next, the control unit 11 estimates, using a known estimation process (e.g., refer to Japanese Unexamined Patent Application Publication No. 2013-167972) usually performed by automotive navigation systems and the like, whether the change target user will be absent from a delivery location indicated by target delivery location information (e.g., delivery location name information “ . . . Higashi-Kanagawa, Kanagawa-ku, Yokohama-shi” and delivery location positional information “ . . . ”), which is the delivery location information obtained in step S52, at a time (e.g., “12/10/2018 17:00”) indicated by the preferred delivery time information obtained in step S52 on the basis of information (e.g., “(35.606218, 139.734931)”) indicating the current position of the change target user obtained in step S53, the target delivery location information, and the preferred delivery time information (step S54).

It is assumed that the control unit 11 determines in step S54 that the change target user will be absent from the delivery location indicated by the target delivery location information (YES in step S54). The control unit 11 refers to the package table Tcb3 (FIG. 17) and obtains delivery location information (e.g., delivery location name information “ . . . Higashi-Kanagawa, Kanagawa-ku, Yokohama-shi” and delivery location positional information “ . . . ”) associated with, among one or more package IDs associated with the vehicle ID (e.g., “TRK0015”) received in step S51, a package ID (e.g., “0987-6543-21”) for identifying a package to be delivered next (step S55). If determining in step S54 that the change target user will be present at the delivery location indicated by the target delivery location information (NO in step S54), on the other hand, the control unit 11 ends the process without performing step S55 and later steps.

After step S55, the control unit 11 calculates, using a known process for finding a route (e.g., refer to Japanese Unexamined Patent Application Publication No. 2009-257940) usually performed by automotive navigation systems and the like, a driving route of the delivery vehicle 4 connecting a position of the delivery location indicated by the target delivery location information obtained in step S52 to a position of a delivery location indicated by the delivery location information (an example of next delivery location information) obtained in step S55 (step S56).

Next, the control unit 11 compares one or more areas that are in one-to-one correspondence with positions of one or more delivery location candidates (an example of one or more target candidates) indicated by one or more user area IDs included in user area information regarding the change target user with the driving route of the delivery vehicle 4 calculated in step S56 (step S57). Each of the one or more areas is an area within the first distance D1 from a position of a corresponding delivery location candidate. That is, the control unit 11 determines in step S57 whether the delivery vehicle 4 can easily deliver the next package with the driving route calculated in step S56, that is, whether there are one or more delivery location candidates within the first distance D1 from the driving route.

More specifically, in step S57, as in step S45 (FIG. 16), the control unit 11 obtains, from the customer table Tcs (FIG. 11), one or more user area IDs (e.g., “CB0011”, “CB0012”, and “LK0080”) associated with the user ID (e.g., “GUEST0020”) of the change target user received in step S52 (step S54). The control unit 11 then compares, as in step S47 (FIG. 16), one or more areas that are in one-to-one correspondence with positions of one or more delivery location candidates indicated by the obtained one or more user area IDs with positions of the driving route of the delivery vehicle 4 calculated in step S56.

It is assumed in step S57 that one or more of the one or more areas that are in one-to-one correspondence with the one or more user area IDs included in the user area information regarding the change target user include a position on the driving route of the delivery vehicle 4 calculated in step S56 (YES in step S57). The one or more areas that are in one-to-one correspondence with the one or more user area IDs included in the user area information regarding the change target user may be referred to as “seventh one or more areas”, and the one or more of the seventh one or more areas including a position on the driving route of the delivery vehicle 4 may be referred to as “eighth one or more areas”.

In this case, as in step S36 (FIG. 14), the control unit 11 generates alternative information for determining one or more delivery location candidates (hereinafter referred to as “one or more close delivery locations”) that are in one-to-one correspondence with the eighth one or more areas as one or more alternative delivery locations and causes the communication unit 12 to transmit the generated alternative information to a user terminal 2 used by the change target user (step S58). Step S8 and the later steps illustrated in FIG. 3 will be performed thereafter.

Take the user area IDs “CB0011” and “LK0080” corresponding to the change target user identified by the user ID “GUEST0020” as an example in step S57. It is assumed that an area within the first distance D1 from a position of a close delivery location indicated by the user area ID “CB0011” includes a position on the driving route of the delivery vehicle 4 and an area within the first distance D1 from a position of a close delivery location indicated by the user area ID “LK0080” includes a position on the driving route of the delivery vehicle 4. In this case, the control unit 11 generates, as alternative information, information including the package ID for identifying the package for the change target user obtained in step S52, the user area IDs “CB0011” and “LK0080” for identifying the close delivery locations, and names “AA Mart Higashi-Kanagawa store” and “Higashi-Kanagawa Station Lockers” of storage locations associated on the area table Tmh1 (FIG. 10), with the same area IDs as the user area IDs “CB0011” and “LK0080” for identifying the close delivery locations. The control unit 11 then causes the communication unit 12 to transmit the generated alternative information to the user terminal 2 used by the change target user.

As a result, if it is estimated that the change target user will be absent from a specified delivery location at a delivery time desired by the change target user, the change target user is notified that the package can be delivered to one or more close delivery locations. The change target user therefore understands that he/she can receive the package at one of the one or more close delivery locations at a convenient time without hurrying to the specified delivery location.

It is assumed that, in step S9 (FIG. 3), the change target user then selects the close delivery location indicated by the user area ID “CB0011” as a delivery location of the package for the change target user. It is also assumed that, in step S10 (FIG. 3), delivery location information indicating the close delivery location is transmitted to the server 1 and the communication unit 12 receives the delivery location information.

In this case, in step S11 (FIG. 3), the control unit 11 causes the communication unit 12 to transmit, to the delivery terminal 3, presentation information indicating that the package for the change target user is to be delivered to the close delivery location indicated by the user area ID “CB0011” indicated by the received delivery location information. More specifically, the control unit 11 causes the communication unit 12 to transmit, to the delivery terminal 3 as presentation information, information including the package ID for identifying the package for the change target user obtained in step S52 and the name “AA Mart Higashi-Kanagawa Store” of the storage location and area positional information “(35.67971, 139.765125)” associated on the area table Tmh1 (FIG. 10) with the same area ID as the user area ID “CB0011”.

Furthermore, the control unit 11 updates the delivery location information associated on the package table Tcb3 (FIG. 17) with the change target user with the received delivery location information, associates the fourth information with the updated delivery location information, and rearranges the one or more records stored in the package table Tcb3 in order of delivery.

More specifically, the control unit 11 updates the delivery location name information “ . . . Higashi-Kanagawa, Kanagawa-ku, Yokohama-shi” associated on the package table Tcb3 (FIG. 17) with the user ID “GUEST0020” of the change target user with the name “AA Mart Higashi-Kanagawa Store” associated on the area table Tmh1 (FIG. 10) with the same area ID as the user area ID “CB0011” for identifying the close delivery location indicated by the received delivery location information.

In addition, the control unit 11 updates the delivery location positional information “ . . . ” associated on the package table Tcb3 (FIG. 17) with the user ID “GUEST0020” of the change target user with the area positional information “(35.67971, 139.765125)” associated on the area table Tmh1 (FIG. 10) with the same area ID as the user area ID “CB0011” for identifying the close delivery location indicated by the received delivery location information.

In addition, the control unit 11 associates the third information stored in the “delivery location type” field of records of the package table Tcb3 (FIG. 17) including the user ID “GUEST0020” of the change target user with the fourth information.

The control unit 11 then sorts, using the known process for finding a shortest route usually performed by automotive navigation systems and the like, the one or more records stored in the package table Tcb3 (FIG. 17) in order of delivery along the driving route of the delivery vehicle 4 determined on the basis of the delivery location information stored in the “delivery location” and “delivery location position” fields.

FIG. 19 illustrates a package table Tcb31 obtained as a result of the update The package table Tcb31 illustrated in FIG. 19 indicates that, as a result of the update, the information stored in the “delivery location”, “delivery location position”, and “delivery location type” fields in a hatched part has been updated. “User area” included in the hatched part is an example of the fourth information. The package table Tcb31 illustrated in FIG. 19 also indicates that, as a result of the update, rearrangement has been performed such that a record including the package ID “0987-6543-21” becomes a first record and a record including the package ID “1234-5678-90” for identifying the package of the change target user becomes a second record.

The above mode is just an example of the embodiment of the present disclosure, and does not limit the present disclosure. For example, following modifications may be implemented.

### First Modification

It is assumed, for example, that a user is absent when a package of food such as frozen foods or perishable foods is delivered to a delivery location originally specified by the user. If there is a storage location that is capable of storing packages of food and that is estimated to have been frequently visited by the user near the delivery location, however, the package may be delivered to the storage location and stored. In this case, the user can easily visit the storage location and receive the stored package without requesting redelivery.

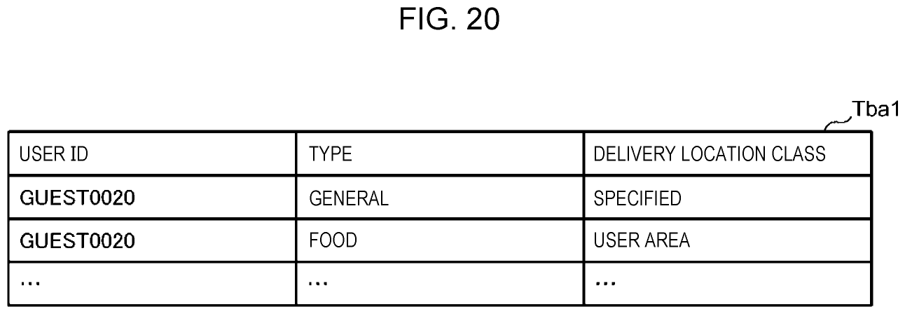

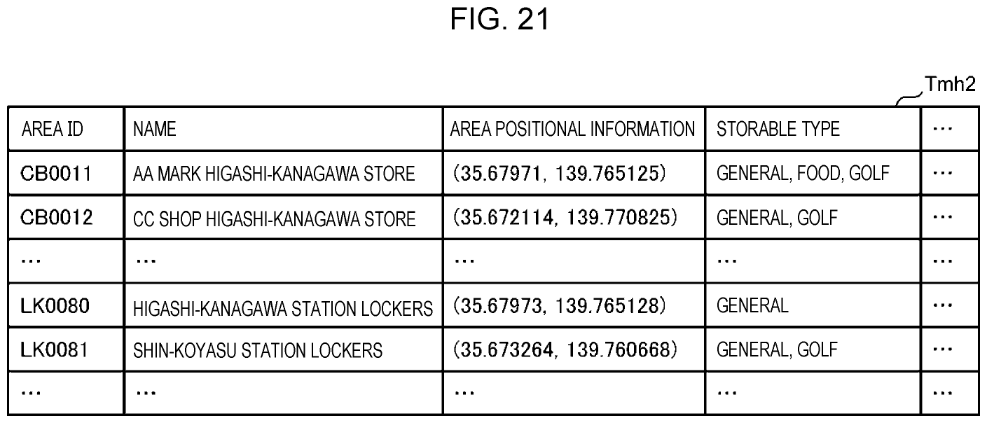

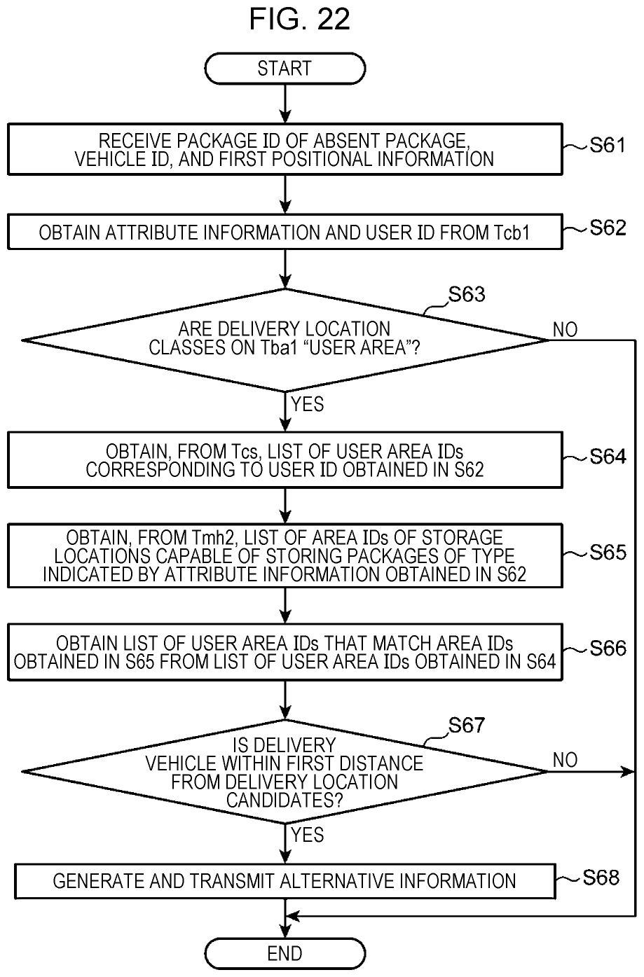

In order to implement a mode in which the user is absent, an attribute-dependent delivery table Tba1 illustrated in FIG. 20 may be achieved by part of the storage area of the memory 13. In addition, the configuration of the area table Tmh1 illustrated in FIG. 10 may be changed to that of an area table Tmh2 illustrated in FIG. 21. In addition, the server 1 may perform a process in accordance with a processing flow illustrated in FIG. 22. FIG. 20 is a diagram illustrating an example of the attribute-dependent delivery table Tba1. FIG. 21 is a diagram illustrating an example of the area table Tmh2. FIG. 22 is a flowchart illustrating a second example of a process performed by the server 1 when the user is absent.

More specifically, as illustrated in FIG. 20, the attribute-dependent delivery table Tba1 includes fields of “user ID”, “type”, and “delivery location type”. The “user ID” field stores user IDs (e.g., “GUEST0020”) for identifying users. The “type” field stores attribute information (e.g., “general” or “food”) indicating types of package for users. The “delivery location class” field stores first information (e.g., “specified”) indicating that a package having an attribute indicated by attribute information stored in the “type” field is to be delivered to a delivery location indicated by delivery location information, which is information stored in the “delivery location” and “delivery location position” fields of the package table Tcb1 illustrated in FIG. 13. Alternatively, the “delivery location class” field stores second information (e.g., “user area”) indicating that a package having an attribute indicated by attribute information stored in the “type” field is to be delivered to one of delivery location candidates included in user area information.

A type of package for each of one or more users and information indicating a delivery location of the package of the type are thus associated with each other on the attribute-dependent delivery table Tba1. One or more records stored in the attribute-dependent delivery table Tba1 correspond to an example of attribute-dependent information.

As illustrated in FIG. 21, the area table Tmh2 includes, as with the area table Tmh1 (FIG. 10), fields of “area ID”, “name”, and “area positional information”. The area table Tmh2 also includes a “storable type” field. The “storable type” field stores type information (e.g., “general”, “food”, and “golf”) indicating one or more types of package storable in storage locations whose names are stored in the “name” field.

In this mode, as in use case 1, first, the control unit 31 causes the communication unit 35 to transmit, to the server 1, a package ID for identifying a pending package input by a driver of a delivery vehicle 4.

As illustrated in FIG. 22, as in steps S31 and S32 (FIG. 14), the communication unit 12 of the server 1 receives the package ID for identifying the pending package from the delivery terminal 3 and a vehicle ID and first positional information periodically transmitted from the delivery terminal 3 (step S61). The control unit 11 refers to the package table Tcb1 (FIG. 13) and obtains attribute information (e.g., “food”) and a user ID (e.g., “GUEST0020”) associated with the package ID (e.g., “1234-5678-90”) received in step S61 (step S62).

Next, the control unit 11 refers to records of the attribute-dependent delivery table Tba1 (FIG. 20) storing, in the “user ID” and “type” fields, the user ID (e.g., “GUEST0020”) and the attribute information (e.g., “food”) obtained in step S62 and determines whether the “delivery location class” field of the records stores the second information (e.g., “user area”) (step S63). The control unit 11 thus determines, if the type of package for the user identified by the user ID obtained in step S62 is the type indicated by the attribute information obtained in step S62, whether the package is to be delivered to one of the delivery location candidates included in the user area information regarding the user.

If determining in step S63 that the second information is stored (YES in step S63), the control unit 11 obtains, as in step S34 (FIG. 14), one or more user area IDs (e.g., “CB0011”, “CB0012”, and “LK0080”) associated on the customer table Tcs (FIG. 11) with the user ID (e.g., “GUEST0020”) obtained in step S62 (step S64). The control unit 11 thus obtains one or more user area IDs for identifying one or more delivery location candidates indicated by user area information regarding a user to whom a pending package is to be delivered.

Next, the control unit 11 obtains, from the area table Tmh2 (FIG. 21), one or more area IDs for identifying one or more storage locations capable of storing packages of the type indicated by the attribute information obtained in step S62 (step S65). More specifically, in step S65, the control unit 11 refers to one or more records including, as type information stored in the “storable type” field, the type (e.g., “food”) indicated by the attribute information obtained in step S62. The control unit 11 then obtains one or more area IDs (e.g., “CB0011”) stored in the “area ID” field of the one or more records.

The control unit 11 then obtains, among the one or more user area IDs (e.g., “CB0011”, “CB0012”, and “LK0080”) obtained in step S64, one or more user area IDs (e.g., “CB0011”) that match the one or more area IDs obtained in step S65 (step S66). The control unit 11 thus obtains one or more user area IDs for identifying one or more delivery location candidates capable of storing a pending package among one or more delivery location candidates indicated by user area information regarding a user to whom the pending package is to be delivered.

Next, as in step S35 (FIG. 14), the control unit 11 performs a process for comparing one or more areas that are in one-to-one correspondence with one or more delivery location candidates indicated by the one or more user area IDs obtained in step S66 with the current position P1 of the delivery vehicle 4 indicated by the first positional information received in step S61 (step S67). Each of the one or more areas is an area within the first distance D1 from a position of a corresponding delivery location candidate. More specifically, the control unit 11 obtains one or more pieces of area positional information associated on the area table Tmh2 (FIG. 21) with the same area IDs as the one or more user area IDs obtained in step S66. The control unit 11 performs step S67 while determining one or more positions indicated by the obtained one or more pieces of area positional information as positions of the one or more delivery location candidates.

It is assumed that one or more of the one or more areas that are in one-to-one correspondence with the one or more user area IDs obtained in step S66 include the current position P1 of the delivery vehicle 4 (YES in step S67). The one or more areas that are in one-to-one correspondence with the one or more user area IDs obtained in step S66 may be referred to as “ninth one or more areas”, and the one or more of the ninth one or more areas including the current position P1 of the delivery vehicle 4 may be referred to as “tenth one or more areas”. In this case, as in step S36 (FIG. 14), the control unit 11 generates alternative information and causes the communication unit 12 to transmit the generated alternative information to a user terminal 2 used by the user identified by the user ID obtained in step S62 (step S68). Step S8 and the later steps illustrated in FIG. 3 will be performed thereafter.

More specifically, in step S68, the control unit 11 generates, as alternative information, information including the package ID received in step S61, user area IDs for identifying one or more alternative delivery locations, which are the one or more delivery location candidates that are in one-to-one correspondence with the tenth one or more areas, and names of storage locations associated on the area table Tmh2 (FIG. 21) with the same area IDs as the user area IDs for identifying the one or more alternative delivery locations.

It is assumed, on the other hand, that the control unit 11 has determined in step S63 that the “delivery location class” field of the records does not store the second information “user area” since the “delivery location class” field stores the first information “specified” (NO in step S63). It is also assumed that, as a result of the comparison process performed in step S67, none of the areas within the first distance D1 from positions of the all delivery location candidates indicated by the user area IDs obtained in step S66 includes the current position P1 of the delivery vehicle 4 (NO in step S67). In these cases, the control unit 11 ends the process without performing step S68. Step S8 and the later steps illustrated in FIG. 3 are not performed either.

According to this mode, after a package ID is received from the delivery terminal 3, attribute information associated on the package table Tcb1 (FIG. 13) with the received package ID is obtained. If the first information is associated on the attribute-dependent delivery table Tba1 (FIG. 20) with the obtained attribute information, alternative information is not transmitted. If a package ID identified by the package ID received from the delivery terminal 3 is a package of a type associated with the first information, therefore, delivery of the package to one of delivery location candidates included in user area information can be appropriately avoided as indicated by the first information.

If the second information is associated on the attribute-dependent delivery table Tba1 (FIG. 20) with the obtained attribute information, on the other hand, alternative information is transmitted. If the package identified by the package ID received from the delivery terminal 3 is a package of a type associated with the second information, therefore, the package can be delivered to one of the delivery location candidates included in the user area information, thereby preventing redelivery.

It is assumed that attribute information associated on the package table Tcb1 (FIG. 13) with the package ID received from the delivery terminal 3 has been obtained and the second information is associated on the attribute-dependent delivery table Tba1 (FIG. 20) with target attribute information, which is the obtained attribute information. In this case, according to this mode, in the comparison process performed in step S67, areas within the first distance D1 from positions of, among the one or more delivery location candidates indicated by the user area IDs included in the user area information regarding the target user, one or more delivery location candidates capable of storing packages of a type indicated by the target attribute information obtained using the area table Tmh2 (FIG. 21) are compared with the current position P1 of the delivery vehicle 4 indicated by the first positional information received from the delivery terminal 3. As a result, the alternative information transmitted to the user terminal 2 does not include one or more alternative delivery locations incapable of storing packages of the type indicated by the target attribute information.

### Second Modification

For example, suppose the user is absent when a package that is heavy or large is delivered to a delivery location originally specified by a user. In this case, even if the package is delivered to and stored in a storage location that is near the delivery location and that is estimated to have been frequently visited by the user, it might be difficult for the user to carry the package to the specified delivery location.

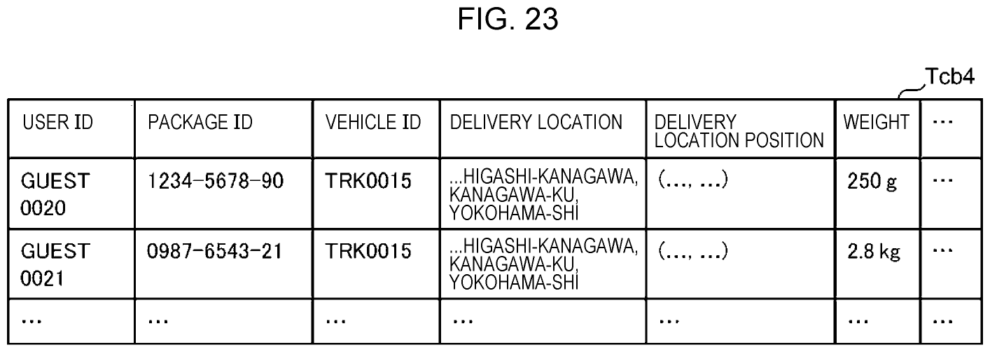

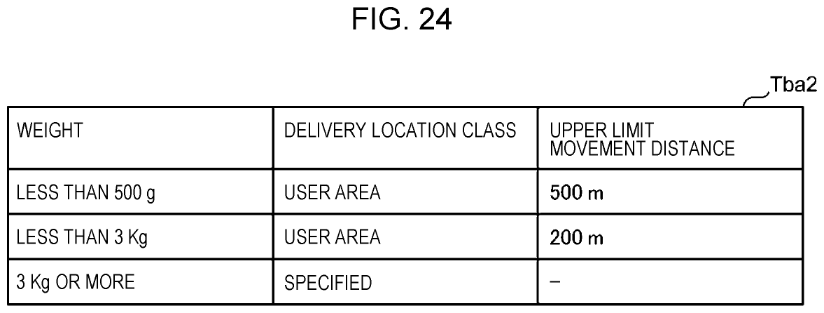

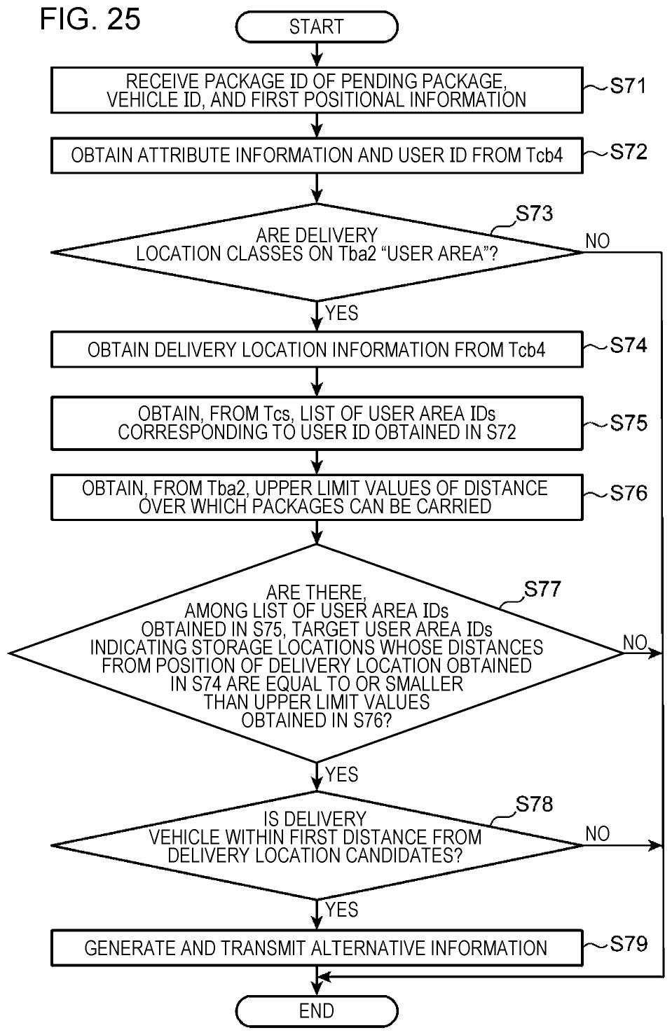

In order to implement a mode for addressing a problem when a user is absent, the configuration of the package table illustrated in FIG. 13 or the like may be changed to that of a package table Tcb4 illustrated in FIG. 23, and the configuration of the attribute-dependent delivery table Tba1 illustrated in FIG. 20 may be changed to that of an attribute-dependent delivery table Tba2 illustrated in FIG. 24. In addition, the server 1 may perform a process in accordance with a processing flow illustrated in FIG. 25. FIG. 23 is a diagram illustrating an example of the package table Tcb4. FIG. 24 is a diagram illustrating an example of the attribute-dependent delivery table Tba2. FIG. 25 is a flowchart illustrating a third example of the process performed by the server 1 when the user is absent.

More specifically, as illustrated in FIG. 23, the package table Tcb4 includes, as with the package table Tcb1 (FIG. 13), fields of “user ID”, “package ID”, “vehicle ID”, “delivery location”, and “delivery location position”. The package table Tcb4 also includes a “weight” field. The “weight” field stores attribute information (e.g., “250 g”) indicating weights of packages identified by package IDs stored in the “package ID” field.

As illustrated in FIG. 24, the attribute-dependent delivery table Tba2 includes fields of “weight”, “delivery location class”, and “upper limit movement distance”. The “weight” field stores attribute information (e.g., “less than 500 g”) indicating weights of packages. The “delivery location class” field stores first information (e.g., “specified”) indicating that a package having a weight indicated by attribute information stored in the “weight” field is to be delivered to a delivery location indicated by delivery location information, which is information stored in the “delivery location” and “delivery location position” fields of the package table Tcb4 illustrated in FIG. 23. Alternatively, the “delivery location class” field stores second information (e.g., “user area”) indicating that a package having a weight indicated by attribute information stored in the “weight” field is to be delivered to one of delivery location candidates included in the user area information.

The “upper limit movement distance” field stores upper limit values (e.g., “500 m”) of distance over which packages having weights (e.g., “less than 500 g”) indicated by attribute information stored in the “weight” field can be carried. Upper limit values are stored in the “upper limit movement distance” field of records storing the second information in the “delivery location class” field, but no upper limit values are stored in the “upper limit movement distance” field of records storing the first information in the “delivery location class” field. That is, upper limit values are associated with attribute information associated on the attribute-dependent delivery table Tba2 with the second information.

The first information is associated on the attribute-dependent delivery table Tba2 with attribute information (e.g., “3 kg or more”) indicating that the weight of a package is equal to or larger than a certain value (e.g., “3 kg”). The second information, on the other hand, is associated on the attribute-dependent delivery table Tba2 with attribute information (e.g., “less than 500 g” or “less than 3 kg”) indicating that the weight of a package is smaller than the certain value (e.g., “3 kg”).

Weights of packages, information indicating delivery locations of the packages having the weights, and upper limit values of distance over which the package having the weights can be carried are thus associated with one another on the attribute-dependent delivery table Tba2. One or more records stored in the attribute-dependent delivery table Tba2 correspond to an example of the attribute-dependent information.

Alternatively, the attribute-dependent delivery table Tba2 may include a “dimension” field storing attribute information (e.g., “less than 50 cm”) indicating dimensions of packages instead of the “weight” field. The dimension of a package refers to, for example, a maximum value among the width, height, and depth of the package. The dimension of a package is not limited to this, and may be an aggregate (sum) of the width, height, and depth of the package or information used by physical distribution companies as the dimension of a package, instead. In this case, the first information may be associated with attribute information (e.g., “50 cm or more”) indicating that the dimension of a package is equal to or larger than a certain value (e.g., “50 cm”), and the second information may be associated with attribute information (e.g., “less than 20 cm” or “less than 50 cm”) indicating that the dimension of a package is smaller than the certain value (e.g., “50 cm”).

In this mode, as in use case 1, first, the control unit 31 causes the communication unit 35 to transmit, to the server 1, a package ID for identifying a pending package input by the driver of the delivery vehicle 4.

As illustrated in FIG. 25, as in steps S31 and S32 (FIG. 14), the communication unit 12 of the server 1 receives a package ID for identifying a pending package from the delivery terminal 3 and a vehicle ID and first positional information periodically transmitted from the delivery terminal 3 (step S71). The control unit 11 refers to the package table Tcb4 (FIG. 23) and attribute information (e.g., “250 g”) and a user ID (e.g., “GUEST0020”) associated with the package ID (e.g., “1234-5678-90”) received in step S71 (step S72).

Next, the control unit 11 refers to records of the attribute-dependent delivery table Tba2 (FIG. 24) storing, in the “weight” field, attribute information (e.g., “less than 500 g”) that matches the attribute information (e.g., “250 g”) obtained in step S72 and determines whether the “delivery location class” field of the records stores the second information (e.g., “user area”) (step S73). The control unit 11 thus determines, if the weight of a package for a user identified by the user ID obtained in step S72 is that indicated by the attribute information obtained in step S72, whether the package is to be delivered to one of delivery location candidates included in user area information regarding the user.

If determining in step S73 that the second information is stored (YES in step S73), the control unit 11 obtains, from the package table Tcb4 (FIG. 23), delivery location information associated with the package ID (e.g., “1234-5678-90”) obtained in step S71, that is, delivery location name information (e.g., “ . . . Higashi-Kanagawa, Kanagawa-ku, Yokohama-shi”) and delivery location positional information (e.g., “( . . . , . . . )”) (step S74).

Next, as in step S34 (FIG. 14), the control unit 11 obtains, from the customer table Tcs (FIG. 11), one or more user area IDs (e.g., “CB0011”, “CB0012”, and “LK0080”) associated with the user ID (e.g., “GUEST0020”) obtained in step S72 (step S75). The control unit 11 thus obtains one or more user area IDs for identifying one or more delivery location candidates indicated by user area information regarding a user to whom a pending package is to be delivered.

Next, the control unit 11 refers to records of the attribute-dependent delivery table Tba2 (FIG. 24) storing, in the “weight” field, attribute information (e.g., “less than 500 g”) that matches the attribute information (e.g., “250 g”) obtained in step S72 and obtains upper limit values (e.g., “500 m”) stored in the “upper limit movement distance” field of the records (step S76).

Next, the control unit 11 refers to the area table Tmh1 (FIG. 10) and determines whether there are, among one or more pieces of area positional information identified by the one or more user area IDs (e.g., “CB0011”, “CB0012”, and “LK0080”) obtained in step S75, one or more user area IDs (hereinafter referred to as “target user area IDs”) whose distances from a delivery location (e.g., “ . . . Higashi-Kanagawa, Kanagawa-ku, Yokohama-shi” or “( . . . , . . . )”) indicated by the delivery location information obtained in step S74 are equal to or smaller than the upper limit values (e.g., “500 m”) obtained in step S76 (step S77). The control unit 11 thus determines whether there are, among one or more delivery location candidates indicated by user area information regarding a user to whom a pending package is to be delivered, one or more delivery location candidates whose distances from a delivery location of the pending package are equal to or smaller than upper limit values of distance over which packages having the weight of the pending package can be delivered.

If determining in step S77 that there are one or more target user area IDs (YES in step S77), the control unit 11 performs, as in step S35 (FIG. 14), a process for comparing one or more areas that are in one-to-one correspondence with positions of the one or more delivery location candidates indicated by the one or more target user area IDs with the current position P1 of the delivery vehicle 4 indicated by the first positional information received in step S71 (step S78). Each of the one or more areas is an area within the first distance D1 from a position of a corresponding delivery location candidate. More specifically, the control unit 11 obtains one or more pieces of area positional information associated on the area table Tmh1 (FIG. 10) with the same area IDs as the one or more target user area IDs and performs step S78 while determining one or more positions indicated by the obtained one or more pieces of area positional information as positions of one or more alternative delivery locations.

It is assumed that, as a result of step S78, one or more of the one or more areas that are in one-to-one correspondence with the one or more target user area IDs include the current position P1 of the delivery vehicle 4 (YES in step S78). The one or more areas that are in one-to-one correspondence with the one or more target user area IDs obtained in step S78 may be referred to as “eleventh one or more areas”, and the one or more of the eleventh one or more areas including the current position P1 of the delivery vehicle 4 may be referred to as “twelfth one or more areas”. In this case, as in step S36 (FIG. 14), the control unit 11 generates alternative information and causes the communication unit 12 to transmit the generated alternative information to a user terminal 2 used by the user identified by the user ID obtained in step S72 (step S79). Step S8 and the later steps illustrated in FIG. 3 will be performed thereafter.

More specifically, in step S79, the control unit 11 generates, as alternative information, information including the package ID received in step S71, user area IDs for identifying one or more alternative delivery locations, which are the one or more delivery location candidates that are in one-to-one correspondence with the twelfth one or more areas, and names of storage locations associated on the area table Tmh1 (FIG. 10) with the same area IDs as the user area IDs for identifying the one or more alternative delivery locations.

It is assumed, on the other hand, that the control unit 11 determines in step S73 that the “delivery location class” field of the records does not store the second information “user area” since the “delivery location class” field stores the first information “specified” (NO in step S73). It is also assumed that the control unit 11 determines in step S77 that there are no one or more target user area IDs (YES in step S77). It is also assumed that, as a result of the comparison process performed in step S78, the control unit 11 determines that none of the areas within the first distance D1 from the positions of all the delivery location candidates indicated by the one or more target user area IDs (NO in step S78). In these cases, the control unit 11 ends the process without performing step S79. Step S8 and the later steps illustrated in FIG. 3 are not performed either.

According to this mode, when a package ID is received from the delivery terminal 3, attribute information associated on the package table Tcb4 (FIG. 23) with the received package ID is obtained. If the first information is associated on the attribute-dependent delivery table Tba2 (FIG. 24) with the obtained attribute information, alternative information is not transmitted. If a package identified by the package ID received from the delivery terminal 3 is a package having a weight associated with the first information, therefore, delivery of the package to one of delivery location candidates included in user area information can be appropriately avoided as indicated by the first information.

If the second information is associated on the attribute-dependent delivery table Tba2 (FIG. 24) with the obtained attribute information, on the other hand, alternative information is transmitted. If the package identified by the package ID received from the delivery terminal 3 is a package having a weight associated with the second information, therefore, the package can be delivered to one of the delivery location candidates included in the user area information as indicated by the second information, thereby reducing redelivery.

It is assumed that attribute information associated on the package table Tcb4 (FIG. 23) with a package ID received from the delivery terminal 3 is obtained and the second information is associated on the attribute-dependent delivery table Tba2 (FIG. 24) with target attribute information, which is the obtained attribute information. In this case, according to this mode, in the comparison process performed in step S78, areas within the first distance D1 from positions of, among one or more delivery location candidates indicated by user area IDs included in user area information regarding a target user, one or more delivery location candidates whose distances from a delivery location originally specified by the target user are equal to or smaller than an upper limit value of distance over which packages having a weight indicated by the target attribute information can be carried are compared with a current position of a delivery vehicle 4 indicated by first positional information received from the delivery terminal 3.

As a result of the comparison process, alternative information transmitted to a user terminal 2 does not include one or more alternative delivery locations whose distances from the delivery location specified by the target user are equal to or larger than the upper limit value of distance over which packages having the weight indicated by the target attribute information. After the target user receives the package at one of the alternative delivery locations, therefore, the target user can carry the package to the specified delivery location.

In addition, according to this mode, since attribute information indicating that the weight of a package is equal to or larger than a certain value is associated on the attribute-dependent delivery table Tba2 (FIG. 24) with the first information, packages having weights equal to or larger than the certain value are not delivered to alternative delivery locations. In contrast, since attribute information indicating that the weight of a package is smaller than the certain value is associated on the attribute-dependent delivery table Tba2 (FIG. 24) with the second information, carriable packages having weights smaller than the certain value can be delivered to alternative delivery locations, thereby reducing redelivery. The same holds when the attribute-dependent delivery table Tba2 (FIG. 24) includes a “dimension” field, which stores attribute information indicating dimensions of packages, instead of the “weight” field as described above.

### Third Modification

Although the same user area information is set for each of one or more users in the above modes, different types of user area information may be set for each of one or more users depending on a time period.

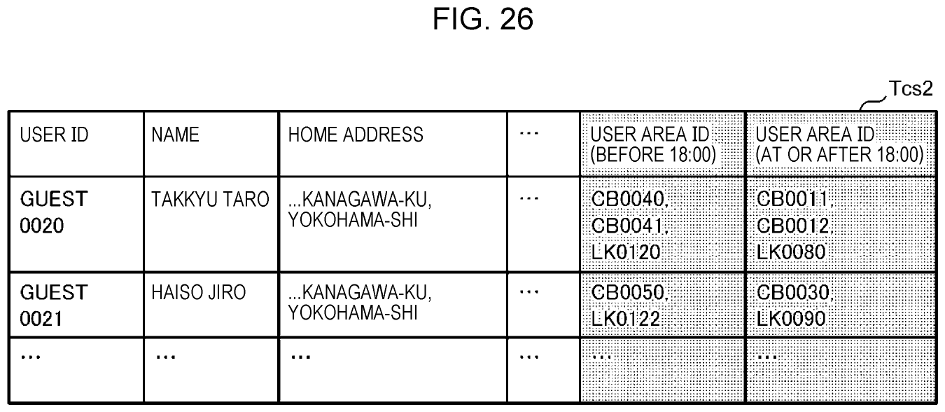

FIG. 26 is a diagram illustrating an example of a customer table Tcs2. The “user area ID” field of the customer table Tcs illustrated in FIG. 11, for example, may be divided, like the customer table Tcs2 illustrated in FIG. 26, into a first field, which stores one or more user area IDs (e.g., “CB0040”, “CB0041”, and “LK0120”) for identifying one or more delivery location candidates determined on the basis of movement history information indicating a history of current positions of users before 18:00, and a second field, which stores one or more user area IDs (e.g., “CB0011”, “CB0012”, and “LK0080”) for identifying one or more delivery location candidates determined on the basis of movement history information indicating a history of current positions of users at or after 18:00.

This configuration can be achieved, for example, by modifying the processing flow illustrated in FIG. 8 in the following manner. Instead of performing steps S25 to S27, the control unit 11 may classify one or more records on the movement history table Tuh (FIG. 9) indicating movement history information regarding a target user identified by a user ID received in step S21 into one or more first records in which times before 18:00 are stored in the “time” field and one or more second records in which times at or after 18:00 are stored in the “time” field.

The control unit 11 may then store, in the first field of the customer table Tcs2, one or more area IDs, the number of which is larger than a second value, included in the one or more first records as one or more user area IDs for identifying one or more delivery location candidates indicated by user area information regarding the target user before 18:00. Similarly, the control unit 11 may store, in the second field of the customer table Tcs2, one or more area IDs, the number of which is larger than the second value, included in the one or more second records as one or more user area IDs for identifying one or more delivery location candidates indicated by user area information regarding the target user at or after 18:00.

In addition, in step S5 (FIG. 3), the control unit 11 may compare one or more delivery location candidates identified by the one or more user area IDs that are associated on the customer table Tcs2 (FIG. 26) with the user ID of the target user and that are stored in the first or second field, whichever corresponds to a time at which first positional information was received, with a current position P1 of a delivery vehicle 4 indicated by the received first positional information.

If the time at which the first positional information was received is 17:30, for example, one or more areas that are in one-to-one correspondence with positions of one or more delivery location candidates indicated by the one or more user area IDs that are associated on the customer table Tcs2 (FIG. 26) with the user ID of the target user and that are stored in the first field with the current position P1 of the delivery vehicle 4 indicated by the received first positional information. Each of the one or more areas is an area within the first distance D1 from a position of a corresponding delivery location candidate.

Similarly, in step S57 (FIG. 18), the control unit 11 may obtain one or more user area IDs that are associated on the customer table Tcs2 (FIG. 26) with a user ID of a change target user and that are stored in the first or second field, whichever corresponds to a time at which first positional information was received. The control unit 11 may then perform a process for comparing one or more areas that are in one-to-one correspondence with positions of one or more delivery location candidates indicated by the obtained one or more user area IDs with a driving route of a delivery vehicle 4 calculated in step S56 (FIG. 18). Each of the one or more areas is an area within the first distance D1 from a position of a corresponding delivery location candidate.

In addition, in step S34 (FIG. 14), S45 (FIG. 16), S64 (FIG. 22), or S75 (FIG. 25), the control unit 11 may obtain one or more user area IDs that are associated on the customer table Tcs2 (FIG. 26) with a user ID and that are stored in the first or second field, whichever corresponds to a time at which first positional information was received.

According to this mode, one or more area IDs, the number of which is larger than the second value, associated in movement history information regarding a user with times in a time period are stored in a memory as one or more user area IDs included in user area information regarding the user corresponding to the time period. As a result, one or more storage locations estimated to have been visited by the user in the time period a number of times equal to or larger than the second value are determined as the user area information regarding the user corresponding to the time period.

If a time at which first positional information was received is within the time period, one or more areas that are in one-to-one correspondence with positions of one or more delivery location candidates indicated by the user area information regarding the user corresponding to the time period are compared with a current position of the delivery vehicle 4 indicated by the received first positional information. Each of the one or more areas is an area within the first distance D1 from a position of a corresponding delivery location candidate. As a result, alternative information indicating that a package can be delivered to one or more alternative delivery locations included in one or more delivery location candidates indicated by user area IDs included in the user area information regarding the user corresponding to the time period is transmitted to a second terminal used by the user in the time period. The user is thus notified at an appropriate timing that the package can be delivered, in the time period, to the one or more alternative delivery locations estimated to have been frequently visited by the user in the time period.

### Fourth Modification

In the above modes, user area information regarding a user is set on the basis of movement history information regarding the user. Because movement history information regarding the user is not stored in the memory 13 just after the user begins to use the presentation system 10, user area information regarding the user is not set. For this reason, area IDs for identifying storage locations within a second distance D1 from positions of addresses of the user's home and/or workplace input by the user may be stored in the “user area ID” field of the customer table Tcs (FIG. 11) or the first and second fields of the customer table Tcs2 (FIG. 26) as user area IDs for identifying one or more delivery location candidates indicated by user area information regarding the user.

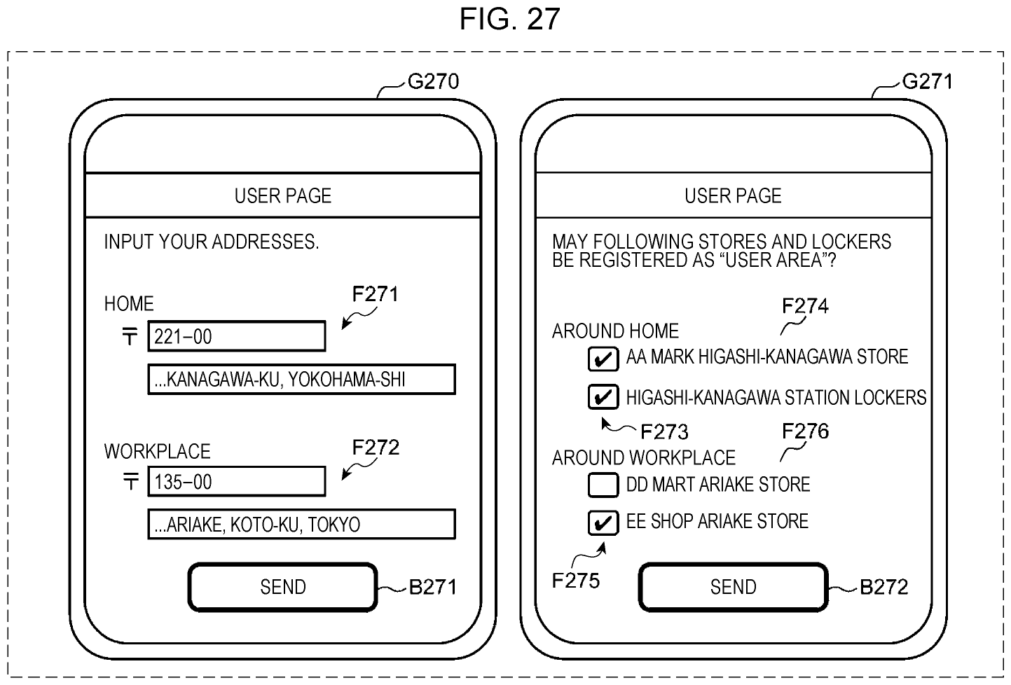

This configuration can be achieved, for example, in the following manner. FIG. 27 is a diagram illustrating an example of operation screens G270 and G271 used by the user to set user area information. When the user inputs an instruction to set user area information using the operation unit 23 of the user terminal 2, the control unit 21 may display, on the display unit 26, the operation screen G270 illustrated in FIG. 27 for inputting addresses of the user's home and workplace.

The operation screen G270 includes a field F271 for inputting the address of the user's home, a field F272 for inputting the address of the user's workplace, and a button B271. If the button B271 is pressed with the address of the user's home input to the field F271 and the address of the user's workplace input to the field F272, the control unit 21 may cause the communication unit 25 to transmit address information indicating the address of the user's home input to the field F271 and the address of the user's workplace input to the field F272 to the server 1 along with a user ID stored in the memory 22.

The communication unit 12 of the server 1 receives the user ID and the address information, and the control unit 11 may refer to the area table Tmh1 (FIG. 10) and obtain one or more area IDs (hereinafter referred to as “first area IDs”) and names (hereinafter referred to as “first names”) of storage locations associated with one or more pieces of area positional information indicating one or more areas within the second distance D2 from a position of the user's home included in the address information. Similarly, the control unit 11 may refer to the area table Tmh1 (FIG. 10) and obtain one or more area IDs (hereinafter referred to as “second area IDs”) and names (hereinafter referred to as “second names”) of storage locations associated with one or more pieces of area positional information indicating one or more areas within the second distance D2 from a position indicated by the address of the user's workplace included in the address information.

The control unit 11 may then transmit the obtained information to the user terminal 2. The communication unit 25 of the user terminal 2 receives the information transmitted from the server 1, and the control unit 21 may display, on the display unit 26, the operation screen G271 indicating one or more delivery location candidates illustrated in FIG. 27.

The operation screen G271 includes a field F273 for selecting storage locations around the user's home, a field F274 for displaying names of the storage locations around the user's home, a field F275 for selecting storage locations around the user's workplace, a field F276 for displaying names of the storage locations around the user's workplace, and a button B272. The control unit 21 may display the first names included in the information transmitted from the server 1 in the field F274 and the second names in the field F276.

It is assumed that the user presses the button B272 with one or more of the names, which are the first names, of the storage locations around the user's home displayed in the field F274 selected using the field F273 and one or more of the names, which are the second names, of the storage locations around the user's workplace displayed in the field F276 selected using the field F275.

In this case, the control unit 21 may cause the communication unit 25 to transmit one or more first area IDs corresponding to the selected one or more names of the storage locations around the user's home and one or more second area IDs corresponding to the selected one or more names of the storage locations around the user's workplace to the server 1 along with the user ID stored in the memory 22.

The communication unit 12 of the server 1 receives the user ID, the one or more first area IDs, and the one or more second area IDs, and the control unit 11 may store the received one or more first area IDs and one or more second area IDs in the “user area ID” field of records of the customer table Tcs (FIG. 11) including the received user ID (FIG. 11). Alternatively, the control unit 11 may store the received one or more first area IDs and one or more second area IDs in the first and second fields of records of the customer table Tcs2 (FIG. 26) including the received user ID.

According to the present disclosure, a package can be delivered to a location convenient for the user and the amount of packages that have to be redelivered can be reduced without increasing travel distance of a delivery vehicle, which is effective in logistics systems for online shopping.

What is claimed is:

1. A presentation apparatus that presents, to a delivery vehicle, information indicating a delivery location of a package to be delivered by the delivery vehicle to each of one or more users, the presentation apparatus comprising:
a memory storing, for each of the one or more users, candidate information indicating one or more delivery location candidates, which are candidates for the delivery location, determined on a basis of movement history information indicating a history of current positions of the user;
a communicator that communicates information with a first terminal, which is an information terminal provided for the delivery vehicle, and one or more second terminals, which are information terminals used by the one or more users; and
a processor that performs a process using information received by the communicator and information stored in the memory,
wherein the memory stores in advance, in order of delivery for the one or more users, package information in which user identifiers for identifying the one or more users, package identifiers for identifying the packages for the one or more users, delivery location information indicating delivery locations specified by the one or more users, third or fourth information, and preferred delivery time information indicating times desired by the one or more users at which the packages are to be delivered associated with one another,
wherein the third information indicates that the delivery location indicated by the delivery location information is a location specified by each of the one or more users and the fourth information indicates that the delivery location indicated by the delivery location information is a location determined on a basis of the candidate information regarding each of the one or more users, and
wherein the processor
obtains a user identifier, delivery location information, and preferred delivery time information associated in the package information with a package identifier of a package to be delivered next,
obtains second positional information indicating a current position of a change target user identified by the obtained user ID from movement history information regarding the change target user,
estimates, on a basis of the obtained second positional information, target delivery location information, which is the obtained delivery location information, and the obtained preferred delivery time information, whether the change target user will be absent from a delivery location indicated by the target delivery location information at the time indicated by the obtained preferred delivery time information,
obtains, if estimating that the change target user will be absent, next delivery location information, which is the delivery location information associated in the package information with the package ID of a next-next package to be delivered,
calculates a driving route of the delivery vehicle from the delivery location indicated by the target delivery location information to a delivery location indicated by the next delivery location information,
compares areas within a first distance from positions of one or more target candidates, which are one or more delivery location candidates indicated by the candidate information regarding the change target user, with positions on the driving route,
causes, if areas within the first distance from the positions of one or more of the one or more target candidates include a position on the driving route, the communicator to transmit alternative information for determining one or more close delivery locations, which are the one or more of the one or more target candidates, as the one or more alternative delivery locations, and
causes, if the communicator receives delivery location information indicating one of the one or more alternative delivery locations from the second terminal used by the change target user, the communicator to transmit, to the first terminal, presentation information indicating that the package for the change target user is to be delivered to the alternative delivery location indicated by the delivery location information.

2. A presentation apparatus that presents, to a delivery vehicle, information indicating a delivery location of a package to be delivered by the delivery vehicle to each of one or more users, the presentation apparatus comprising:
a memory storing, for each of the one or more users, candidate information indicating one or more delivery location candidates, which are candidates for the delivery location, determined on a basis of movement history information indicating a history of current positions of the user and delivery location information indicating a delivery location specified by the user;
a communicator that communicates information with a first terminal, which is an information terminal provided for the delivery vehicle, and one or more second terminals, which are information terminals used by the one or more users; and
a processor that performs a process using information received by the communicator and information stored in the memory,
wherein the memory stores the delivery location candidates, type information indicating storable types of package, and upper limit movement distances, which are upper limit values of distance over which the packages are carriable from the delivery location candidates to the delivery locations indicated by the delivery location information, while associating the delivery location candidates, the type information, and the upper limit movement distances with one another, and
wherein the processor
obtains attribute information indicating food as a type of package, refers to the type information stored in the memory, and generates information regarding delivery location candidates capable of storing the package,
performs, if the communicator receives, from the first terminal, first positional information indicating a current position of the delivery vehicle, a process for comparing, for each of the one or more users, areas within a first distance from positions of the one or more delivery location candidates indicated by the candidate information regarding a target user with the current position of the delivery vehicle indicated by the received first positional information,
causes, if areas within the first distance from positions of one or more of the one or more delivery location candidates include the current position of the delivery vehicle, the communicator to transmit, to the second terminal used by the target user, alternative information indicating that the package for the target user is deliverable to one or more alternative delivery locations, which are the one or more of the one or more delivery location candidates, and
causes, if the communicator receives delivery location information indicating one of the one or more alternative delivery locations from the second terminal used by the target user, the communicator to transmit, to the first terminal, presentation information indicating that the package for the target user is to be delivered to the alternative delivery location indicated by the delivery location information.

3. A presentation apparatus that presents, to a delivery vehicle, information indicating delivery locations of packages to be delivered by the delivery vehicle to users, the presentation apparatus comprising:
a memory storing, for each of the users, candidate information indicating one or more delivery location candidates, which are candidates for the delivery location, determined on a basis of movement history information indicating a history of current positions of the user;
a communicator that communicates information with a first terminal, which is an information terminal provided for the delivery vehicle, and one or more second terminals, which are information terminals used by the users; and
a processor that performs a process using information received by the communicator and information stored in the memory,
wherein the memory stores in advance, for each of the users, package information in which a user identifier for identifying the user, a package identifier for identifying the package for the user, and destination information indicating a destination at a time when the delivery vehicle delivers the package to the user are associated with one another, and
wherein the processor
calculates, on a basis of one or more pieces of the destination information included in the package information, a driving route for the delivery vehicle to complete the delivery,
compares, if the candidate information regarding the users includes one or more common candidates, which are one or more delivery location candidates, a number of which is equal to or larger than a certain value, included in different pieces of the candidate information in common, areas within a first distance from positions of the one or more common candidates with positions on the driving route, and
causes, if areas within the first distance from positions of one or more of the one or more common candidates include a position on the driving route, the communicator to transmit, to second terminals used by one or more notification target users, who correspond to one or more pieces of the candidate information including one or more common delivery locations, which are the one or more of the one or more common candidates, alternative information for determining the one or more common delivery locations included in the candidate information regarding the one or more notification target users as one or more alternative delivery locations.

4. A presentation apparatus that presents information indicating delivery locations of packages, the presentation apparatus comprising:
a memory storing, for each of one or more users, candidate information indicating one or more delivery location candidates, which are candidates for the delivery location;
a communicator that communicates information with a first terminal, which is an information terminal provided for a delivery vehicle, and one or more second terminals, which are information terminals used by the one or more users; and
a processor that performs a process using information received by the communicator and information stored in the memory,
wherein the processor
obtains second positional information indicating a current position of one of the one or more users and target delivery location information and preferred delivery time information regarding the package to be delivered,
estimates, on a basis of the second positional information, the target delivery location information, and the preferred delivery time information, whether the user will be absent from a delivery location indicated by the target delivery location information at a time indicated by the obtained preferred delivery time information,
obtains, if determining that the user will be absent, next delivery location information, which is delivery location information regarding a package to be delivered next,
calculates a driving route of the delivery vehicle from the delivery location indicated by the target delivery location information to a delivery location indicated by the next delivery location information,
compares areas within a first distance from positions of one or more target candidates, which are stored in the memory and which are delivery location candidates for the user, with positions on the driving route, and
causes, if the areas include a position on the driving route, the communicator to transmit, to the second terminal used by the user, one or more pieces of alternative delivery location information indicating one or more target location candidates.

5. A presentation apparatus that presents information indicating delivery locations of packages, the presentation apparatus comprising:
a memory storing, for each of one or more users, candidate information indicating one or more delivery location candidates, which are candidates for the delivery location, and delivery location information indicating a delivery location specified by the user;
a communicator that communicates information with a first terminal, which is an information terminal provided for a delivery vehicle, and one or more second terminals, which are information terminals used by the one or more users; and
a processor that performs a process using information received by the communicator and information stored in the memory,
wherein the memory stores the delivery location candidates, type information indicating storable types of package, and upper limit movement distances, which are upper limit values of distance over which the packages are carriable from the delivery location candidates to the delivery locations indicated by the delivery location information, while associating the delivery location candidates, the type information, and the upper limit movement distances with one another, and
wherein the processor
obtains attribute information indicating food as a type of package, refers to the type information stored in the memory, and generates information regarding one or more delivery location candidates capable of storing the package, and
causes the communicator to transmit, to the second terminal used by a target user, alternative information indicating that the package for the target user is deliverable to one or more alternative delivery locations, which are the one or more delivery location candidates.

6. A presentation apparatus that presents information indicating delivery locations of packages for users, the presentation apparatus comprising:
a memory storing, for each of the users, candidate information indicating one or more delivery location candidates, which are candidates for the delivery location;
a communicator that communicates information with a first terminal, which is an information terminal provided for the delivery vehicle, and one or more second terminals, which are information terminals used by the users; and
a processor that performs a process using information received by the communicator and information stored in the memory,
wherein the memory stores in advance, for the users, package information in which user identifiers for identifying the users, package identifiers for identifying the packages for the users, and destination information indicating destinations at a time when the delivery vehicle delivers the packages to the users are associated with one another, and
wherein the processor
calculates, on a basis of one or more pieces of the destination information included in the package information, a driving route for the delivery vehicle to complete the delivery,
compares, if the candidate information regarding the users includes one or more common candidates, which are one or more delivery location candidates, a number of which is equal to or larger than a certain value, included in different pieces of the candidate information in common, areas within a first distance from positions of the one or more common candidates with positions on the driving route, and
causes, if areas within the first distance from positions of one or more of the one or more common candidates include a position on the driving route, the communicator to transmit, to second terminals used by one or more notification target users, who correspond to one or more pieces of the candidate information including one or more common delivery locations, which are the one or more of the one or more common candidates, alternative information for determining the one or more common delivery locations included in the candidate information regarding the one or more notification target users as one or more alternative delivery locations.
